(19) United States
(12) Patent Application Publication
(10) Pub. No.: US 2023/0292273 A1
(43) Pub. Date: Sep. 14, 2023

(54) SYSTEMS AND METHODS FOR PROVIDING TIMING ADVANCE (TA) VALUES

(71) Applicant: HUAWEI TECHNOLOGIES CO., LTD., SHENZHEN (CN)

(72) Inventors: LIQING ZHANG, Kanata (CA); JIANGLEI MA, Kanata (CA); YONGXIA LYU, Shenzhen (CN)

(21) Appl. No.: 18/317,509

(22) Filed: May 15, 2023

Related U.S. Application Data
(63) Continuation of application No. PCT/CN2020/133004, filed on Dec. 1, 2020.

(51) Int. Cl. H04W 56/00

(52) U.S. Cl. CPC H04W 56/0045

(57) ABSTRACT

A timing advance (TA) value is a time offset that may be applied by a UE to compensate for the propagation delay of the UE and thereby cause the UE's uplink transmissions to be time synchronized with the uplink transmissions of other UEs. However, a UE may possibly operate in different states, and in some states (e.g. a power saving state) the UE does not maintain uplink synchronization. If the UE has information to transmit, and the UE is operating in a state in which there is no uplink synchronization, then the overhead of performing uplink synchronization in order to transmit the information must be incurred. Systems and method are instead disclosed for providing TA values to maintain timing synchronization, e.g. even when the UE is in a power-saving state.

### CROSS-REFERENCE TO RELATED APPLICATION

The present application is a continuation of PCT International Application PCT/CN2020/133004, titled “Systems and Methods for Providing Timing Advance (TA) Values”, filed on Dec. 1, 2020, and incorporated herein by reference.

### FIELD

The present application relates to wireless communication, and more specifically to providing timing advance (TA) values to be used for timing synchronization, e.g. for uplink synchronization.

### BACKGROUND

In some wireless communication systems, user equipments (UEs) wirelessly communicate with one or more base stations. A wireless communication from a UE to a base station is referred to as an uplink communication. A wireless communication from a base station to a UE is referred to as a downlink communication. Resources are required to perform uplink and downlink communications. For example, a base station may wirelessly transmit data to a UE in a downlink communication at a particular frequency for a particular duration of time. The frequency and time duration are examples of resources, typically referred to as “time-frequency resources”.

Two devices that wirelessly communicate with each other over time-frequency resources need not necessarily be a UE and a base station. For example, two UEs may wirelessly communicate with each other over a sidelink using device-to-device (D2D) communication. As another example, two network devices (e.g. a terrestrial base station and a non-terrestrial base station, such as a drone) may wirelessly communicate with each other over a backhaul link.

When devices wirelessly communicate with each other, time synchronization of communications arriving from multiple devices may be desired. For example, in the context of uplink communication, a base station may wish to ensure that the uplink communications from different UEs all arrive at the base station time aligned with each other, e.g. to ensure that the downlink and uplink sub-frames/symbols are synchronized at the base station. However, different UEs are typically at different locations relative to the base station, such that each UE may have a different signal propagation delay to/from the base station. In the absence of a timing synchronization mechanism, the uplink transmissions from the different UEs will typically not arrive at the base station at the same time because of the varying propagation delays.

A timing advance (TA) value is a time offset that may be applied by a UE to compensate for the propagation delay of the UE and thereby cause the UE's uplink transmissions to be time synchronized with the uplink transmissions of other UEs. The base station may provide a respective TA value to each UE that is dependent upon that UE's propagation delay, e.g. dependent upon the round trip time (RTT), which is also referred to as the round trip delay. Different UEs may therefore have different TA values. The UE may apply a negative time offset between the start of a received downlink time and a transmitted uplink time, where the negative time offset is based on the TA value. The TA value may be computed by the base station, e.g. using a preamble transmitted by the UE, and then provided to the UE for use by the UE to perform the negative offset.

However, a device such as a UE may possibly operate in different states, e.g. a power saving state, connected state, handover state, etc. In some states, e.g. when a UE is in a power saving state, such as in an Inactive or Idle state, the UE does not maintain uplink synchronization. If the UE has information (e.g. data or control information) to transmit, and the UE is operating in a state in which there is no uplink synchronization, then the overhead of performing uplink synchronization in order to transmit the information must be incurred. For example, the UE has to first transmit a random access response (RACH) preamble and receive a TA value in random access response (RAR) message. The TA value may then be used to time offset the transmission of the information to have uplink synchronization.

### SUMMARY

Apparatuses and method are disclosed for providing TA values to maintain timing synchronization.

In some embodiments, an apparatus (such as a UE) may receive a TA value even when operating in a power saving state, such as in an Inactive or Idle state, so that uplink synchronization can be maintained. As an example, a UE operating in a power saving state may wake up and receive a TA value from a base station to maintain uplink synchronization. Because uplink synchronization is maintained, when the UE has information to transmit, e.g. low latency data, the UE may transmit the information immediately without having to first obtain a TA value for uplink synchronization. The following technical benefit may therefore be achieved in some embodiments: a UE may maintain uplink synchronization even with the UE is not in a connected state, e.g. when the UE is in a power saving state, such as an Inactive or Idle state.

In some embodiments, a group message is used to carry one more TA values for one or more apparatuses, e.g. a group message may be used to communicate one or more TA values for a group of UEs being served by a base station. In some embodiments, a common TA value may be provided in the group message for use by some or all of the UEs in the group. The common TA value may be a single value that is based, for example, on an average of the TA values for the UEs. The following technical benefit may therefore be achieved in some embodiments: transmission of a common TA value to reduce overhead compared to sending separate respective TA values for each of the UEs. In some embodiments, for one or more of the UEs receiving the common TA value, an updated TA value might subsequently be provided to the UE. The updated TA value may be in the form of an adjustment that is to be applied to the common TA value in order to try to result in a more accurate TA value for the UE.

In some embodiments, a TA value is provided in physical layer control signaling. The following technical benefit may therefore be achieved in some embodiments: dynamic indication of a TA value. In some embodiments, the TA value may be provided via a unicast message or via a group message.

In some embodiments, other information (which may be associated with timing advance or synchronization) may be provided along with a TA value. For example, a UE being sent a TA value may also be sent, along with the TA value, a timing reference point, and/or beam direction configuration information, and/or downlink/uplink or uplink/downlink switching time, and/or other offsets associated with the round trip propagation delay for that UE, etc. The following technical benefit may therefore be achieved in some embodiments: indication of supplementary or complementary information along with a TA value.

The embodiments are not limited to synchronizing uplink communications, but are applicable to any scenario in which a TA value is used for the time synchronization of transmissions. Uplink transmissions by a UE are what are discussed in many of the example embodiments herein, but TA values could be used for transmissions between UEs (e.g. over a sidelink), transmissions between network devices (e.g. over a backhaul link), transmissions to/from a satellite or a drone, etc. Some embodiments may be implemented in applications such as satellite communication and/or Internet of Vehicle (IoV), etc.

In one embodiment, there is provided a method performed by an apparatus. The method may include receiving physical layer control signaling. The physical layer control signaling may carry a group message including TA-related information. The group message is for a group of apparatuses including the apparatus. The method may further include decoding the group message to obtain the TA-related information. In some embodiments, the TA-related information may indicate at least one TA value. In some embodiments, the TA-related information may indicate a time-frequency resource in a data channel at which at least one TA value is located. In some embodiments, the at least one TA value may be a common TA value. In some embodiments, the at least one TA value may include a respective TA value for each of one or more apparatuses in the group. An apparatus to perform the methods is also disclosed. The apparatus may be a UE or a network device.

In another embodiment, there is provided a method performed by a device. The method may include determining at least one TA value for one or more apparatuses in a group of apparatuses. The method may further include transmitting physical layer control signaling. The physical layer control signaling may carry a group message for the group of apparatuses. The group message may include TA-related information. The TA-related information may be associated with the at least one TA value, e.g. the TA-related information may indicate the at least one TA value, or the TA-related information may indicate a time-frequency resource in a data channel at which the at least one TA value is located. A device to perform the methods is also disclosed. The device may be a network device or a UE.

In another embodiment, there is provided a method performed by an apparatus. The method may include receiving physical layer control signaling. The physical layer control signaling may carry a TA value for the apparatus. The method may further include decoding the TA value. In some embodiments, the TA value may be received in a unicast message. In some embodiments, the TA value may be received during a wake-up duration of the apparatus when the apparatus is in a power saving state. An apparatus to perform the methods is also disclosed. The apparatus may be a UE or a network device.

In another embodiment, there is provided a method performed by a device. The method may include determining a TA value for an apparatus. The method may further include transmitting physical layer control signaling to the apparatus. The physical layer control signaling may carry the TA value for the apparatus. In some embodiments, the TA value may be determined based on the position of the apparatus. In some embodiments, the TA value may be transmitted in a unicast message. A device to perform the methods is also disclosed. The device may be a network device or a UE.

### BRIEF DESCRIPTION OF THE DRAWINGS

Embodiments will be described, by way of example only, with reference to the accompanying figures wherein:

FIG. 1 is a network diagram of an example communication system;

FIG. 2 is a block diagram of an example electronic device;

FIG. 3 is a block diagram of another example electronic device;

FIG. 4 is a block diagram of example component modules;

FIG. 5 is a block diagram of an example user equipment and base station;

FIG. 6 is a block diagram of an example apparatus and device;

FIG. 7 illustrates power consumption for a UE operating in a single state, according to one embodiment;

FIG. 8 illustrates a table indicating when the uplink timing error will become unacceptably large, according to one embodiment;

FIG. 9 illustrates two examples in which a group message directly indicates one or more TA values;

FIG. 10 illustrates two examples in which TA-related information in a group message schedules a TA message in a data channel;

FIGS. 11 and 12 each illustrate a method performed by a base station and a plurality of UEs, according to different embodiments;

FIG. 13 illustrates power consumption for a UE operating in a single power-saving state, according the embodiment in FIG. 7;

FIG. 14 illustrates a method performed by a base station and a UE, according to one embodiment;

FIG. 15 illustrates power consumption for a UE operating in a single power-saving state, according the embodiment in FIG. 7; and

FIGS. 16 to 18 illustrate methods performed by an apparatus and a device, according to various embodiments.

### DETAILED DESCRIPTION

For illustrative purposes, specific example embodiments will now be explained in greater detail below in conjunction with the figures.

### Example Communication Systems and Devices

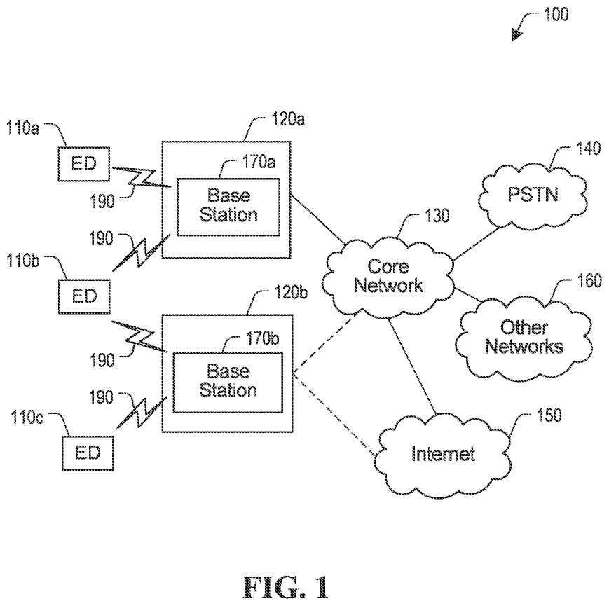

FIG. 1 illustrates an example communication system 100. In general, the communication system 100 enables multiple wireless or wired elements to communicate data and other content. The purpose of the communication system 100 may be to provide content, such as voice, data, video, and/or text, via broadcast, narrowcast, multicast, unicast, user device to user device, etc. The communication system 100 may operate by sharing resources, such as bandwidth.

In this example, the communication system 100 includes electronic devices (ED) 110a-110c, radio access networks (RANs) 120a-120b, a core network 130, a public switched telephone network (PSTN) 140, the internet 150, and other networks 160. Although certain numbers of these components or elements are shown in FIG. 1, any reasonable number of these components or elements may be included in the communication system 100.

The EDs 110a-110c are configured to operate, communicate, or both, in the communication system 100. For example, the EDs 110a-110c are configured to transmit, receive, or both via wireless or wired communication channels. Each ED 110a-110c represents any suitable end user device for wireless operation and may include such devices (or may be referred to) as a user equipment/device (UE), wireless transmit/receive unit (WTRU), mobile station, fixed or mobile subscriber unit, cellular telephone, station (STA), machine type communication (MTC) device, personal digital assistant (PDA), smartphone, laptop, computer, tablet, wireless sensor, consumer electronics device, car, truck, bus, train, drone, etc.

In FIG. 1, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB or eNB), a Home eNodeB, a gNodeB, a transmission point (TP), a site controller, an access point (AP), or a wireless router. Any ED 110a-110c may be alternatively or additionally configured to interface, access, or communicate with any other base station 170a-170b, the internet 150, the core network 130, the PSTN 140, the other networks 160, or any combination of the preceding. The communication system 100 may include RANs, such as RAN 120b, wherein the corresponding base station 170b accesses the core network 130 via the internet 150.

The EDs 110a-110c and base stations 170a-170b are examples of communication equipment that can be configured to implement some or all of the functionality and/or embodiments described herein. In the embodiment shown in FIG. 1, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b communicate with one or more of the EDs 110a-110c over one or more air interfaces 190 using wireless communication links e.g. radio frequency (RF), microwave, infrared (IR), etc. The air interfaces 190 may utilize any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190.

A base station 170a-170b may implement Universal Mobile Telecommunication System (UMTS) Terrestrial Radio Access (UTRA) to establish an air interface 190 using wideband CDMA (WCDMA). In doing so, the base station 170a-170b may implement protocols such as HSPA, HSPA+ optionally including HSDPA, HSUPA or both. Alternatively, a base station 170a-170b may establish an air interface 190 with Evolved UTMS Terrestrial Radio Access (E-UTRA) using LTE, LTE-A, and/or LTE-B. It is contemplated that the communication system 100 may use multiple channel access functionality, including such schemes as described above. Other radio technologies for implementing air interfaces include IEEE 802.11, 802.15, 802.16, CDMA2000, CDMA2000 1×, CDMA2000 EV-DO, IS-2000, IS-95, IS-856, GSM, EDGE, and GERAN. Other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160). In addition, some or all of the EDs 110a-110c may include functionality for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as IP, TCP, UDP. EDs 110a-110c may be multimode devices capable of operation according to multiple radio access technologies, and incorporate multiple transceivers necessary to support such.

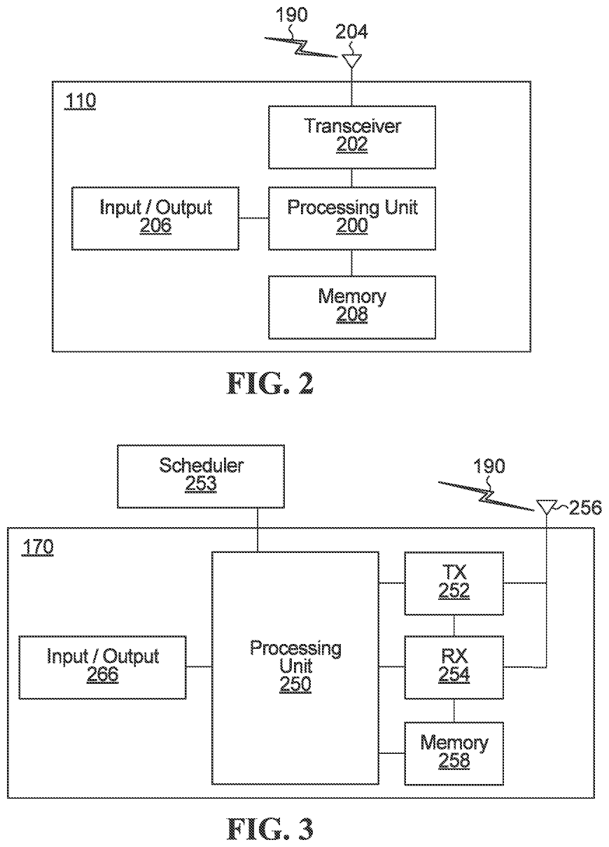

FIGS. 2 and 3 illustrate example devices that may implement the methods and teachings according to this disclosure. In particular, FIG. 2 illustrates an example ED 110, and FIG. 3 illustrates an example base station 170. These components could be used in the communication system 100 or in any other suitable system.

As shown in FIG. 2, the ED 110 includes at least one processing unit 200. The processing unit 200 implements various processing operations of the ED 110. For example, the processing unit 200 could perform signal coding, data processing, power control, input/output processing, or any other functionality enabling the ED 110 to operate in the communication system 100. The processing unit 200 may also be configured to implement some or all of the functionality and/or embodiments described in more detail herein. Each processing unit 200 includes any suitable processing or computing device configured to perform one or more operations. Each processing unit 200 could, for example, include a microprocessor, microcontroller, digital signal processor, field programmable gate array, or application specific integrated circuit.

The ED 110 also includes at least one transceiver 202. The transceiver 202 is configured to modulate data or other content for transmission by at least one antenna 204 or Network Interface Controller (NIC). The transceiver 202 is also configured to demodulate data or other content received by the at least one antenna 204. Each transceiver 202 includes any suitable structure for generating signals for wireless or wired transmission and/or processing signals received wirelessly or by wire. Each antenna 204 includes any suitable structure for transmitting and/or receiving wireless or wired signals. One or multiple transceivers 202 could be used in the ED 110. One or multiple antennas 204 could be used in the ED 110. Although shown as a single functional unit, a transceiver 202 could also be implemented using at least one transmitter and at least one separate receiver.

The ED 110 further includes one or more input/output devices 206 or interfaces (such as a wired interface to the internet 150). The input/output devices 206 permit interaction with a user or other devices in the network. Each input/output device 206 includes any suitable structure for providing information to or receiving information from a user, such as a speaker, microphone, keypad, keyboard, display, or touch screen, including network interface communications.

In addition, the ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 200. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 3, the base station 170 includes at least one processing unit 250, at least one transmitter 252, at least one receiver 254, one or more antennas 256, at least one memory 258, and one or more input/output devices or interfaces 266. A transceiver, not shown, may be used instead of the transmitter 252 and receiver 254. A scheduler 253 may be coupled to the processing unit 250. The scheduler 253 may be included within or operated separately from the base station 170. The processing unit 250 implements various processing operations of the base station 170, such as signal coding, data processing, power control, input/output processing, or any other functionality. The processing unit 250 can also be configured to implement some or all of the functionality and/or embodiments described in more detail herein. Each processing unit 250 includes any suitable processing or computing device configured to perform one or more operations. Each processing unit 250 could, for example, include a microprocessor, microcontroller, digital signal processor, field programmable gate array, or application specific integrated circuit.

Each transmitter 252 includes any suitable structure for generating signals for wireless or wired transmission to one or more EDs or other devices. Each receiver 254 includes any suitable structure for processing signals received wirelessly or by wire from one or more EDs or other devices. Although shown as separate components, at least one transmitter 252 and at least one receiver 254 could be combined into a transceiver. Each antenna 256 includes any suitable structure for transmitting and/or receiving wireless or wired signals. Although a common antenna 256 is shown here as being coupled to both the transmitter 252 and the receiver 254, one or more antennas 256 could be coupled to the transmitter(s) 252, and one or more separate antennas 256 could be coupled to the receiver(s) 254. Each memory 258 includes any suitable volatile and/or non-volatile storage and retrieval device(s) such as those described above in connection to the ED 110. The memory 258 stores instructions and data used, generated, or collected by the base station 170. For example, the memory 258 could store software instructions or modules configured to implement some or all of the functionality and/or embodiments described above and that are executed by the processing unit(s) 250.

Each input/output device 266 permits interaction with a user or other devices in the network. Each input/output device 266 includes any suitable structure for providing information to or receiving/providing information from a user, including network interface communications.

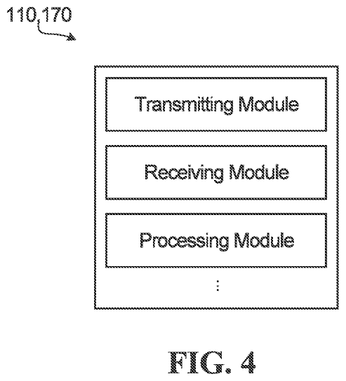

One or more steps of the embodiment methods provided herein may be performed by corresponding units or modules, according to FIG. 4. FIG. 4 illustrates units or modules in a device, such as in ED 110 or base station 170. For example, a signal may be transmitted by a transmitting unit or a transmitting module. A signal may be received by a receiving unit or a receiving module. A signal may be processed by a processing unit or a processing module. The processing module may encompass the units/modules described later, e.g. the processor 210 or processor 260. Other units/modules may be included in FIG. 4, but are not shown. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Additional details regarding the EDs 110 and the base stations 170 are known to those of skill in the art. As such, these details are omitted here for clarity.

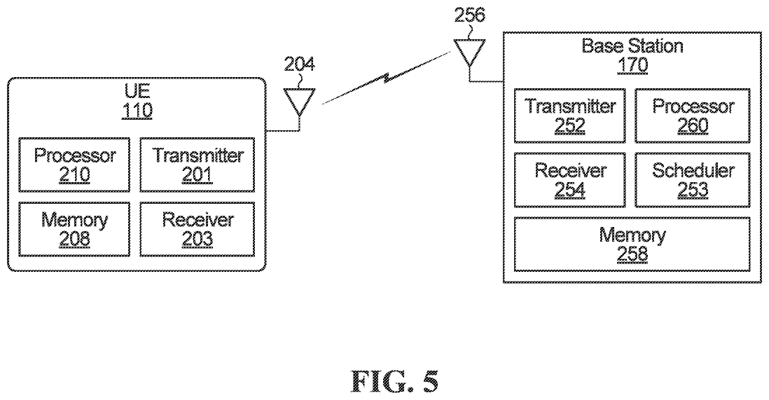

FIG. 5 illustrates another example of an ED 110 and a base station 170. The ED 110 will hereafter be referred to as a user equipment (UE) 110.

The base station 170 may be called other names in some implementations, such as a transmit-and-receive point (TRP), a transmit-and-reception point, a base transceiver station, a radio base station, a network node, a transmit/receive node, a Node B, an evolved NodeB (eNodeB or eNB), a gNB, a relay station, or a remote radio head. In some embodiments, the parts of the base station 170 may be distributed. For example, some of the modules of the base station 170 may be located remote from the equipment housing the antennas of the base station 170, and may be coupled to the equipment housing the antennas over a communication link (not shown). Therefore, in some embodiments, the term base station 170 may also refer to modules on the network side that perform processing operations, such as resource allocation (scheduling), message generation, encoding/decoding, etc., and that are not necessarily part of the equipment housing the antennas and/or panels of the base station 170. For example, the modules that are not necessarily part of the equipment housing the antennas/panels of the base station 170 may include one or more modules that generate the TA values discussed herein, that generate the unicast and group messages discussed herein, that generate the physical layer control signaling discussed herein, etc. The modules may also be coupled to other base stations. In some embodiments, the base station 170 may actually be a plurality of base stations that are operating together to serve the UE 110, e.g. through coordinated multipoint transmissions. In some embodiments, some or all of the base station 170 may be non-terrestrial, e.g. mounted on a flying device, such as a drone or satellite.

The base station 170 includes a transmitter 252 and a receiver 254 coupled to one or more antennas 256. Only one antenna 256 is illustrated. One, some, or all of the antennas may alternatively be panels. The transmitter 252 and the receiver 254 may be integrated as a transceiver. The base station 170 further includes a processor 260 for performing operations including those related to preparing a transmission for downlink transmission to the UE 110, and those related to processing uplink transmissions received from the UE 110. Processing operations related to preparing a transmission for downlink transmission may include operations such as encoding, modulating, precoding (e.g. MIMO precoding), beamforming, etc. Processing operations related to processing uplink transmissions may include operations such as beamforming, demodulating, and decoding. The processor 260 may implement much of the operations described herein as being performed by the base station 170, e.g. determining the position of the UE 110, determining TA values, generating a group or unicast message, e.g. by encoding the message, generating the physical layer control signaling, generating the TA message transmitted in the data channel, etc. The base station 170 further includes a scheduler 253, which may schedule the uplink resources to be allocated to UE 110 for uplink transmissions, and which may also schedule downlink transmissions. The base station 100 further includes a memory 258 for storing information and data.

Although not illustrated, the processor 260 may form part of the transmitter 252 and/or receiver 254. Also, although not illustrated, the processor 260 may implement the scheduler 253.

The processor 260, the scheduler 253, and the processing components of the transmitter 252 and receiver 254 may each be implemented by the same or different one or more processors that are configured to execute instructions stored in a memory (e.g. in memory 258). Alternatively, some or all of the processor 260, the scheduler 253, and the processing components of the transmitter 252 and receiver 254 may be implemented using dedicated circuitry, such as a programmed field-programmable gate array (FPGA), a graphical processing unit (GPU), or an application-specific integrated circuit (ASIC).

The UE 110 also includes a transmitter 201 and a receiver 203 coupled to one or more antennas 204. Only one antenna 204 is illustrated. One, some, or all of the antennas may alternatively be panels. The transmitter 201 and the receiver 203 may be integrated as a transceiver, e.g. transceiver 202 of FIG. 2. The UE 110 further includes a processor 210 for performing operations including those related to preparing a transmission for uplink transmission to the base station 170, and those related to processing downlink transmissions received from the base station 170. Processing operations related to preparing a transmission for uplink transmission may include operations such as encoding, modulating, precoding (e.g. MIMO precoding), beamforming, etc. Processing operations related to processing downlink transmissions may include operations such as beamforming, demodulating, and decoding, e.g. decoding the TA-related information or TA value in a received transmission. The processor 210 may perform many of the operations described herein as being performed by UE 110, e.g. receiving the physical layer control signaling, decoding the received messages (e.g. the group message), decoding TA-related information and/or a TA value, etc. The decoding implemented depends upon the manner in which the information was encoded, e.g. information encoded using a polar code is decoded using a polar decoding algorithm, etc.

Although not illustrated, the processor 210 may form part of the transmitter 201 and/or receiver 203.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a FPGA, a GPU, or an ASIC.

In some embodiments, the UE 110 might be one or more of the following: a smartphone; an Internet of Things (IoT) device; a wearable device; a vehicular device (e.g. a vehicle-mounted device, or vehicle on-board equipment); etc.

The base station 170 and the UE 110 may include other components, but these have been omitted for the sake of clarity.

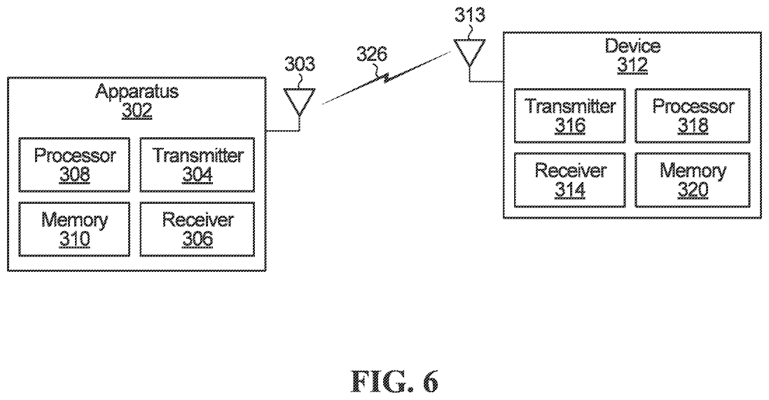

Embodiments are not limited to uplink and/or downlink communication. More generally, two devices may be wirelessly communicating with each other, and one of the devices may apply a TA value to offset a transmission so that the transmission is time synchronized with other transmissions from other devices. FIG. 6 illustrates two devices wirelessly communicating, according to one embodiment. To more easily distinguish between the two devices, one will be referred to as apparatus 302 and the other will be referred to as device 312. The apparatus 302 may be a UE, e.g. UE 110. The device 312 may be a network device, e.g. a base station or a non-terrestrial network node, such as a drone or satellite. However, this is not necessary. For example, the apparatus 302 may be a UE or network device, and the device 312 may be a UE or a network device. The terms “apparatus” 302 and “device” 312 are simply used to more easily distinguish between the two entities. They may be the same type of entity, e.g. the apparatus 302 and the device 312 may both be UEs, or the apparatus 302 and the device 312 may both be network devices (e.g. base stations), although more generally this is not necessary.

In remaining embodiments, the device 312 is assumed to be one determining and providing a TA value, and the apparatus 302 is assumed to be the one receiving the TA value and performing a transmission with a time offset that is based on the TA value. For example, the device 312 may be a base station and the apparatus 302 may be a UE transmitting information in an uplink transmission with a time offset equal to a TA value provided by the device 312.

The device 312 includes a transmitter 316 and receiver 314, which may be integrated as a transceiver. The transmitter 316 and receiver 314 are coupled to one or more antennas 313. Only one antenna 313 is illustrated. One, some, or all of the antennas may alternatively be panels. The device 312 further includes a processor 318 for generating the TA value to be sent to the apparatus 302 and, more generally, for generating the transmissions to be sent to the apparatus 302. For example, the processor 318 may encode the TA value and include it in dynamic signaling, e.g. include it for transmission in physical layer control signaling in a control channel (e.g. in DCI), or include it in a data channel. Although not illustrated, the processor 318 may form part of the transmitter 316 and/or receiver 314. The device 312 further includes a memory 320 for storing information and data.

The processor 318 and processing components of the transmitter 316 and receiver 314 may be implemented by the same or different one or more processors that are configured to execute instructions stored in a memory (e.g. in memory 320). Alternatively, some or all of the processor 318 and/or processing components of the transmitter 316 and/or receiver 314 may be implemented using dedicated circuitry, such as a programmed FPGA, a GPU, or an ASIC.

If the device 312 is base station 170, then the processor 318 may be or include processor 260, the transmitter 316 may be or include transmitter 252, the receiver 314 may be or include receiver 254, and the memory 320 may be or include memory 258.

The apparatus 302 includes a transmitter 304 and a receiver 306, which may be integrated as a transceiver. The transmitter 304 and receiver 306 are coupled to one or more antennas 303. Only one antenna 303 is illustrated. One, some, or all of the antennas may alternatively be panels.

The apparatus 302 further includes a processor 308 for processing the transmission received by the device 312, e.g. decoding the message to obtain the TA-related information, etc. Although not illustrated, the processor 308 may form part of the transmitter 304 and/or receiver 306. The apparatus 302 further includes a memory 310 for storing information and data.

The processor 308 and processing components of the transmitter 304 and/or receiver 306 may be implemented by the same or different one or more processors that are configured to execute instructions stored in a memory (e.g. in memory 310). Alternatively, some or all of the processor 308 and/or processing components of the transmitter 304 and/or receiver 306 may be implemented using dedicated circuitry, such as a programmed FPGA, a GPU, or an ASIC.

If the apparatus 302 is UE 110, then the processor 308 may be or include processor 210, the transmitter 304 may be or include transmitter 201, the receiver 306 may be or include receiver 203, and the memory 310 may be or include memory 208.

The apparatus 302 and the device 312 may include other components, but these have been omitted for the sake of clarity.

Specific example embodiments will now be described in the context of uplink synchronization, e.g. in the context of the UE 110 receiving a TA value from the base station 170 and applying the TA value to time offset uplink communications sent from the UE 110. However, as described above, the embodiments are not limited to UE and base station communication, but may apply to any situation in which an apparatus 302 receives a TA value from a device 312 and uses the TA value to time offset a transmission from the apparatus 302 for the purposes of timing synchronization.

### UE Operation in Different States

In some embodiments, a UE 110 may operate in different states, e.g. a power saving state, connected state, handover state, etc. When operating in certain states, e.g. when operating in a power saving state, the UE 110 might not fully occupy the system resources available for downlink and/or uplink transmission, e.g. the UE might not utilize all transmission parameters and time-frequency resources available for downlink and/or uplink transmission. For example, the UE 110 might not constantly (or as often) monitor for network instructions on the downlink, e.g. the UE 110 might not monitor a control channel, such as the physical downlink control channel (PDCCH), as often. For example, if the UE 110 is a reduced capacity (RedCap) commercial device, a wearable devices, a low cost industry wireless devices, an internet of thing (IoT) device, etc., then the UE 110 may operate in a power saving state much or all of the time.

In some embodiments, when not operating in the power saving state, e.g. when the UE 110 operates in a normal, enhanced, or higher power-consumption state, the UE 110 may fully occupy the system resources (e.g. the transmission parameters and/or time-frequency resources) that are available for uplink and/or downlink transmission, and/or the UE may constantly (or more often) monitor for network instructions on the downlink. For example, the UE may monitor the PDCCH regularly or more often than when in the power saving state.

In some wireless communication systems, the UE 110 and network operate according to a radio resource control (RRC) protocol. The RRC protocol has different states in terms of the UE operating behaviour and radio resource usage. For example, the RRC protocol may include: an RRC Idle state in which there is no RRC connection established with the network and no actual RRC configured resources used; a RRC Connected (Active) state in which an RRC connection is established and full RRC configured radio resources are used by the UE; and an RRC Inactive state in which partial RRC resources are reserved and the RRC functions of the UE may be reduced, e.g. to help save power. In some embodiments, the Idle and Inactive states may be considered power saving states.

In some embodiments, within a single state (e.g. within a power saving state) there may be different operation modes that consume different amounts of UE power, e.g. a default operation mode and an enhanced operation mode. Each operation mode may correspond to a respective power (usage) mode. Example power modes might include sleep, wake-up, downlink reception only, both downlink reception and uplink transmission mode, etc. Multiple modes may be within a single state, and/or different states may have different modes. In some cases, transitioning from one mode to another mode might involve changing state. For example, the modes of “sleep” and “downlink reception only” might be two different power modes in a same power saving state, whereas the mode “both downlink reception and uplink transmission” may be a mode in a non-power-saving state (or normal transmit/receive power state).

In some embodiments, after or upon completing initial access to connect to the network, the UE 110 enters a default operation mode that is associated with lower power consumption and is within a power saving state. The UE 110 remains in the default operation mode by default, and only temporarily moves into an enhanced operation mode on demand, e.g. upon arrival of uplink data to transmit to the base station 170. Moving into the enhanced operation mode might or might not cause the UE 110 to transition to a new or different state.

In some embodiments, when the UE 110 is in a power saving state, monitoring the downlink control channel, e.g. for downlink control information (DCI), might only be performed in a wake-up period of a discontinuous reception (DRX) cycle or DRX_on window.

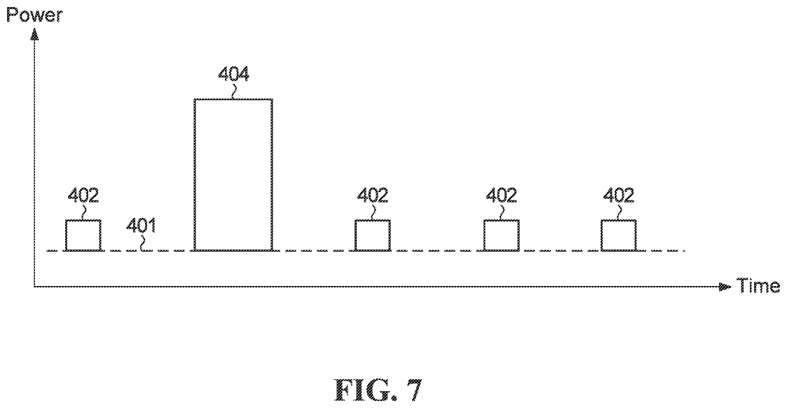

For the sake of example, FIG. 7 illustrates power consumption for the UE 110 when operating in a single power-saving state, according to one embodiment. Within the single state, the UE 110 may operate in different power modes, in particular: a default sleep mode, which is a very low power mode when in a sleep duration; a wake-up mode, which is a low power mode when in a wake-up duration (e.g. when in a wake-up period of a DRX cycle); and a temporary higher power mode for relatively short transmission or reception of data. The default sleep mode is indicated by dashed line 401. Periodic wake-up durations 402 are interspersed between the sleep durations, e.g. possibly at regular intervals, such as according to a DRX cycle. In a wake-up duration 402, the UE 110 consumes more power in order to perform operations such as monitoring for downlink information (e.g. monitoring for DCI), possible measurements of the channel, etc. Each wake-up duration 402 might possibly be a wake-up period of a DRX cycle or DRX_on window, depending upon the implementation. Occasionally, there might be a relatively short duration of time in which data is to be transmitted or received by the UE 110. For example, data may arrive at the UE 110 for transmission to the base station 110. The data may be of a relatively small size or transmission duration, and/or the data may be low latency data, such that transitioning to a higher-power connected state is not needed and possibly not supported (e.g. if the UE 110 only operates in a single state having different power modes). Therefore, instead, at time duration 404, the UE 110 transitions to a higher power mode to transmit and/or receive the data. The location and/or length of time duration 404 may be configured (semi-statically/dynamically) or predefined, and/or may be associated with the UE traffic. In one example, downlink control signaling received by UE 110 in the wake-up duration 402 prior to duration 404 may configure duration 404. Upon completion of duration 404, the UE 110 transitions back to sleep mode.

In some states or modes of operation, e.g. when operating in a power saving state and/or in a lower power mode, the UE 110 might not maintain uplink synchronization. For example, the UE 110 might not have a TA value, or the TA value may be considered stale, where the TA is directly associated with the round-trip delay between the UE and a network node (e.g., a base station). The following problem occurs: when the UE 110 is to send an uplink transmission, e.g. in duration 404 of FIG. 7, the UE 110 needs to first obtain a TA value to apply as a time offset to the uplink transmission for the purposes of uplink synchronization. For example, the UE 110 has to first transmit a random access response (RACH) preamble and receive the TA value in random access response (RAR) message. This causes delay and overhead.

For example, in some implementations in new radio (NR), UE uplink/downlink synchronization with the network is maintained in an Active state, but not in an Inactive or Idle state. The Inactive and Idle states may be considered power saving states that aim to reduce unnecessary activity and save UE power. For uplink/downlink transmission, the UE is not synchronized in a power saving state and has to transition from a power saving state to an Active (Connected) state for synchronization and data transmission/reception. For example, upon traffic arrival (e.g., uplink data transmission), the UE in a power saving state will need to search one or more synchronization signal block (SSB) sets and perform a physical random access procedure, e.g. on a physical random access channel (PRACH), which may take at least 2-5 ms depending on the SSB pattern, frequency band, and PRACH configuration. However, in future wireless networks, data rate may be fast, and for a burst of traffic, active transmission and reception period is short, such that it might make sense for the UE to remain in a power saving state most or all of the time (i.e. not in an Active state accessing the network). This may allow for minimizing activities and power usage, e.g., just performing a wake-up check, a limited channel measurement, cell reselection, etc. Remaining in a power saving state may be particularly desirable for UEs built to have low power consumption, e.g. simple devices and/or devices with energy saving characteristics. Upon traffic arrival in the power saving state, the UE ideally would perform fast access to the network for downlink/uplink reception/transmission, e.g., for scheduling-free (“grant-free”) uplink transmission. This may also allow for the support of enhanced ultra-reliable low latency communication (URLLC) services with low latency data transmission. However, there is no UE synchronization maintained in power saving states (e.g. in Inactive or Idle states) in previous (e.g., LTE, NR) networks.

Instead, in some embodiments below, the UE 110 maintains uplink synchronization, even when the UE 110 is in a power saving state. For example, with reference to FIG. 7, in some embodiments the UE 110 may receive an updated TA value during a wake-up duration 402, e.g. in downlink physical layer control signaling or in a downlink data channel (e.g. at a time-frequency resource that is scheduled by physical layer control signaling). The TA value may be transmitted to the UE 110 in a group message or in a unicast message. The TA value may be based on positioning information of the UE 110, although not necessarily. Many different variations are discussed below.

However, examples of ways in which a TA value for UE 110 may be determined and/or updated are first described.

### Determining and Updating TA Values

In some embodiments, the base station 170 may determine a TA value for a UE 110 using a preamble received from the UE 110, such as a RACH preamble. For example, the base station may apply a correlation of the known preamble with the received preamble at different times, determine a time at which the output of the correlation provides the highest energy, use that time to estimate the timing of the start of the received uplink transmission, compare the start of the received uplink transmission to the expected timing of the base station reception, and obtain a TA value from the comparison based on the difference between the start of the received uplink transmission and the expected timing of the base station reception. The TA value may then be transmitted to the UE, e.g. in the physical layer control signaling (like in some embodiments discussed later), or alternatively in a data channel or in a higher layer, such as in the MAC layer. A random access response (RAR) response is an example of a message that may include a TA value and that is transmitted in the MAC layer.

More generally, in some embodiments a TA value for the UE 110 may be computed by the base station 170 using an uplink signal from the UE 110. The uplink signal will be referred to as an uplink touch signal (UTS), and it may be a preamble (e.g. a RACH preamble), but not necessarily. For example, the UTS might be one or more of the following: a preamble; a dedicated uplink synchronization signal; a sounding signal; a sounding reference signal (SRS); a sensing signal; a measurement report (such as a radio resource management (RRM) measurement report); a positioning report (such as GPS, a position to reference point or network nodes); a sensing report; a demodulation reference signal (DMRS); uplink data or traffic; an uplink pilot (which may be a preamble, a measurement pilot/reference signal, a demodulation pilot/reference signal); range/distance measurements from a reference position. The timing of the uplink transmission may be determined from the UTS to obtain the TA value, e.g. in the same way a preamble is used to determine the TA value as described above, and/or the content in the UTS itself (e.g. an indication of the position of the UE relative to the base station 170) may be used to determine the TA value. The TA value may be sent to the UE in physical layer control signaling, higher layer signaling (e.g. RRC or MAC CE), or in a data channel.

In some embodiments, e.g. when the UE 110 is in a power saving state, the UE 110 might not send a UTS to the base station 170 at all or often enough for the base station 170 to determine and/or update the TA value for the UE 110. Therefore, in some embodiments, the base station 170 may determine and/or update a TA value for a UE 110 using information relating to the position (“positioning information”) of the UE 110. If the base station 170 knows the position of UE 110 relative to the base station 170, then the base station 170 can map the position to a round trip delay, e.g. via a predefined mapping that maps each location (or area) in the region served by the base station 170 to a respective round trip delay. The mapping may be implemented using a look-up-table. The mapping may take into account network planning (e.g. if some locations are known to be line-of-sight and others are known not to be line-of-sight). The round trip delay maps directly to a corresponding TA value because the TA value is the indication of the timing offset required to compensate for the round trip delay. In some embodiments, a mapping (e.g. a look-up-table) might not be used, e.g. the base station 170 may compute, in real-time or near real-time, the TA value based on a particular position of the UE 110, e.g. factoring in the speed of light, environmental factors (e.g. buildings), distance from base station 170, etc.

A non-exhaustive list of example ways in which the base station 170 may determine or maintain the position of a UE 110 is as follows:
GPS coordinates of the UE 110 may be transmitted to the base station 170, and the GPS coordinates may be used as the position of the UE 110, or used to determine the position of the UE 110.
The use of positioning reference signals, e.g. the UE 110 transmits a positioning reference signal (PRS) to each of a plurality of base stations, and the network uses the known location of those base stations and the time difference between the times at which each PRS was received in order to estimate the position of the UE 110. The opposite may also occur, e.g. the plurality of base stations each transmit a respective PRS that is received by the UE 110, and then the UE 110 reports the time difference between the received PRSs to the base station 170, which is then used to estimate the position of the UE.
UE positioning sensing by the base station 170, e.g. using radio wave measurements (e.g. radar), and/or acoustic measurements (echolocation), and/or detecting Wi-Fi signals, and/or lidar measurements, etc. For example, the base station 170 performs a beam sweep of radio waves, e.g. radar, and receives a reflection back from a particular direction having a strong reflective signal. The reflected signal is interpreted as the presence of a UE. A signal might then be sent to that UE to request that the UE respond with its UE ID to determine whether the UE is UE 110, another UE, or not a UE at all.
Tracking the UE 110's previous one or more positions and, based at least on that tracking data, predicting the position of the UE 110, e.g. using artificial intelligence, such as a machine learning algorithm in which the past positions of a UE are input into a trained machine learning algorithm that returns a prediction of the future or current position of that UE.
The UE 110 periodically transmits a signal (which may be a UTS) to the base station 110, e.g. at a predefined time and/or in reply to an interrogator signal. The contents and/or strength and/or direction of the signal is indicative of the position of the UE.
The UE 110 senses its environment, e.g. using radio wave measurements (e.g. radar), and/or acoustic measurements (echolocation), and/or detecting Wi-Fi signals, and/or lidar measurements, etc. The results of the sensing measurements provide an indication of the environment surrounding the UE 110. Information relating to the environment is then transmitted to the base station 110 and is used by the base station 110 to estimate the position of the UE.

A position of a UE may be expressed in precise terms, e.g. particular GPS coordinates, or (x,y,z) coordinates in relation to the base station 110. A position of a UE may instead be expressed in more general terms, e.g. within a particular or general area or region.

When “TA value” is used herein, unless otherwise qualified the TA value may be an absolute TA value or a relative TA value. An absolute TA value is an absolute indication of the TA value, whereas a relative TA value is an indication of an adjustment/delta from a previously known TA value. For example, an absolute TA value may be provided to the UE 110 upon initial access, and subsequently the TA value may be updated using relative TA values. In some previous implementations, e.g. in new radio (NR), an absolute TA value may be provided in a random access response (RAR) message in the MAC layer (in response to a RACH preamble) and a relative TA value subsequently sent in a MAC CE.

In some embodiments, the TA value may be updated over time, e.g. as the UE 110 moves. For example, the base station 170 may determine/maintain a UE's position as the UE moves, and from the UE's position knows the round trip delay between the base station and the UE. Based on the changing round trip delay, the base station can maintain/update the TA value for the UE. Updating a current TA value for a UE is referred to as a TA adjustment. In some embodiments, a TA adjustment might be required in order to keep the UE's uplink timing within a certain timing error limit Tₑ. Therefore, in some embodiments, approaching the timing error limit Tₑ may act as a trigger for the base station to send a TA adjustment to the UE. The timing error limit Tₑ may be a function of particular parameters, such as a function of the frequency range on which the UE is communicating, the subcarrier spacing (SCS), etc.

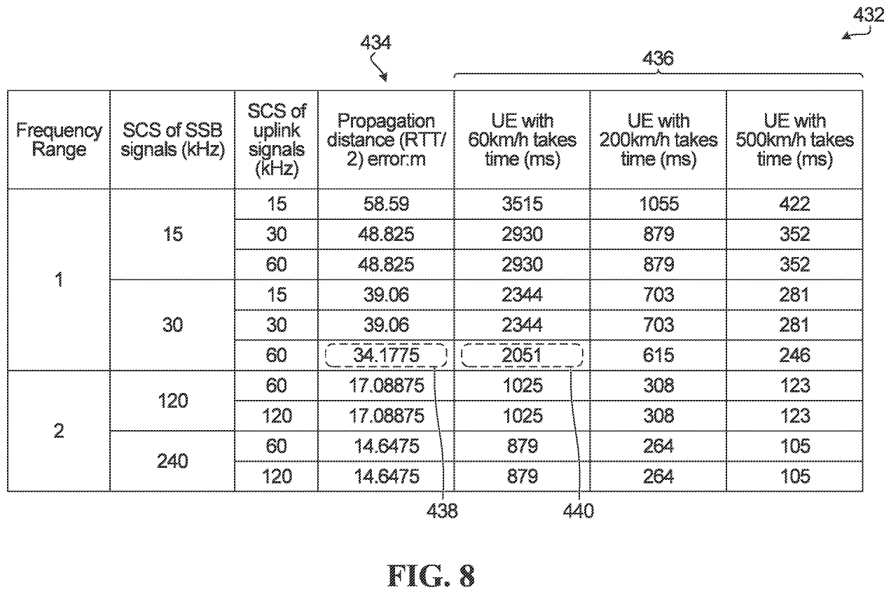

In some embodiments in which the base station 170 determines and/or updates the TA value for UE 110 based, at least in part, on the position of the UE 110, the base station 170 may maintain a table in which the timing error limit is expressed in terms of change in propagation distance (RTT/2) from the base station 170 and/or change in UE speed. For example, FIG. 8 illustrates an example table 432, which may be stored in memory at base station 170. Column 434 of the table indicates, for each frequency range and SCS, the propagation distance (in meters) that a UE may change, relative to the base station, before the uplink timing error will become unacceptably large. The TA value needs to be updated before the change in propagation distance exceeds the value in the table 432. For example, if UE 110 uses a current TA value that is based on a 200 meter propagation distance from the base station 170, and the UE 110 operates in frequency range 1 with a SCS of SSB signals of 30 kHz and a SCS of uplink signals of 60 kHz, then a change of up to 34.1775 meters in propagation distance from the base station 170 is acceptable before the TA value becomes too inaccurate, as shown at 438 in the table 432. For example, the propagation distance from the base station 170 for UE 110 may change 200±34 meters without the TA value becoming too inaccurate. The TA value for the UE 110 needs to be updated before the propagation distance changes more than 34.1775 meters. Columns 436 illustrate the maximum amount of time that can elapse between TA updates for when the UE 110 is moving at different speeds, assuming the UE 110 is moving in a direction that directly changes the propagation distance from the base station 170. For example, if UE 110 is moving at 60 km/h away from or towards the base station 170, then for operation in frequency range 1 with a SCS of SSB signals of 30 kHz and a SCS of uplink signals of 60 kHz, the UE 110 requires its TA value to be updated at least once every 2051 ms, as shown at 440 in table 432. In some embodiments, a base station 170 may use table 432 or the equivalent as a guide for setting up a schedule of how often the TA value is to be updated for a UE. In some embodiments, special or different handling may be implemented for TA value computation/update on handover or cell reselection. For example, UE tracking on handover or cell-reselection may require special handling. In such embodiments, beam selection may also require special handling if narrow beams are used. Sending a TA value in a wideband beam may be preferred.

In some embodiments, a single same TA value (e.g., absolute TA or/and relative TA) may be transmitted to more than one UE, e.g. in a group message. For example, if a group of UEs are in close proximity to each other, each UE in the group may be sent the same TA value, either as a single value in a group message, or in unicast messages. The single same TA value sent to more than one UE will be referred to as a “common TA value”. A common TA value may be an absolute TA. One example situation in which a common TA value may be used is when a group of UEs have gathered closely together, e.g. in a same vehicle. Another example situation in which a common TA value may be used is when several UEs are fixed in close proximity to each other, e.g. different utility meters installed all next to each other, or different chipsets (UEs) in a same robotic arm, etc. In some embodiments, a common TA value can be a relative TA; for example, after a group of UEs have received and applied the absolute TA, a common TA value with relative TA may be used when the group of UEs have gathered closely together, e.g. in a same vehicle.

If a common TA value is transmitted to a particular UE, then in some embodiments an updated TA value (e.g. an adjusted TA value that is relative to the common TA value) may subsequently be transmitted to the UE to try to better reflect the uplink timing of that particular UE and thereby achieve more accurate uplink synchronization. For example, a group of UEs may all be sent a same common TA value, which is suitable for use by each UE in the group, but is a “compromise” value, e.g. based on the average propagation distance of the group and not optimized for any one particular UE in the group. One or more of the UEs may then be sent an updated TA value (e.g. a TA adjustment) that better reflects the uplink timing of that UE. The UE then modifies/adjusts the common TA value based on the updated TA value. In some embodiments, the updated TA value may be sent in response to an UTS sent by the UE. The UTS might or might not be sent having a timing offset based on the common TA value. Specific examples will be described later.

In some embodiments, the UE 110 may communicate with more than one base station at a time. If the UE 110 transmits uplink signals individually to each of multiple base stations, then the UE 110 might employ a different TA value for each base station. However, if aggregation is implemented such that the UE 110 sends a single uplink transmission meant for several base stations, then a single same TA value may be used for those base stations. Therefore, in general, there may be TA groups (TAGs), where each group is associated with an uplink transmission destined for a group of base stations. A TA value (e.g., usually a compromised value for a group of the base stations) may be used and maintained for each TAG. Therefore, although the TA value in embodiments herein is discussed in relation to a single base station, in general the TA value may be a value used for an aggregated uplink communication destined for multiple base stations.

In some embodiments, TA-related information may be transmitted from base station 170 to UE 110. TA-related information is information related to timing advance. For example, the TA-related information may be or include a TA value itself, e.g. an explicit indication of a TA value for a UE. As another example, the TA-related information may be information needed to obtain one or more TA values from a data channel, e.g. the TA-related information may be control information indicating a time-frequency resource in a data channel at which a TA value is located.

Regardless of how TA values or TA-related information is determined, it may be transmitted to the UE 110 in physical layer control signaling (e.g. in DCI), or in higher-layer signaling (e.g. RRC or MAC CE), or in a data channel. It may be sent in a group message or in a unicast message. Different examples are provided herein.

### Providing a TA Value Via a Group Message

In some embodiments, a group message may be transmitted in physical layer control signaling to a plurality of UEs in a group. The group message may be associated with a group ID that identifies the group, e.g. each UE in the group may have the group ID, and each UE may know that it is part of the group having that group ID. In some embodiments, the group ID may be configured by the base station 170 or predefined, and it may be a timing advance-specific group ID, e.g. a timing advance radio network temporary identifier (TA-RNTI). In some embodiments, the group message may be transmitted in a downlink control channel, e.g. in a PDCCH. In some embodiments, the group message may be part of the DCI. In some embodiments, the group message or the DCI may have its cyclic redundancy check (CRC) masked (e.g. scrambled) using the group ID. For example, the group message may be or include physical layer control information, e.g. DCI, that is used to generate a CRC, and the CRC is then scrambled by the group ID. A UE in the group may perform blind decoding on a control channel with unmasking using the group ID, e.g. by unscrambling the CRC using the group ID by performing an XOR operation between the masked CRC and the group ID. When unmasking using the group ID is successful (e.g. the unscrambled CRC results in a correct CRC value match), then the group message may be decoded by the UE. The contents of the group message may include TA-related information.

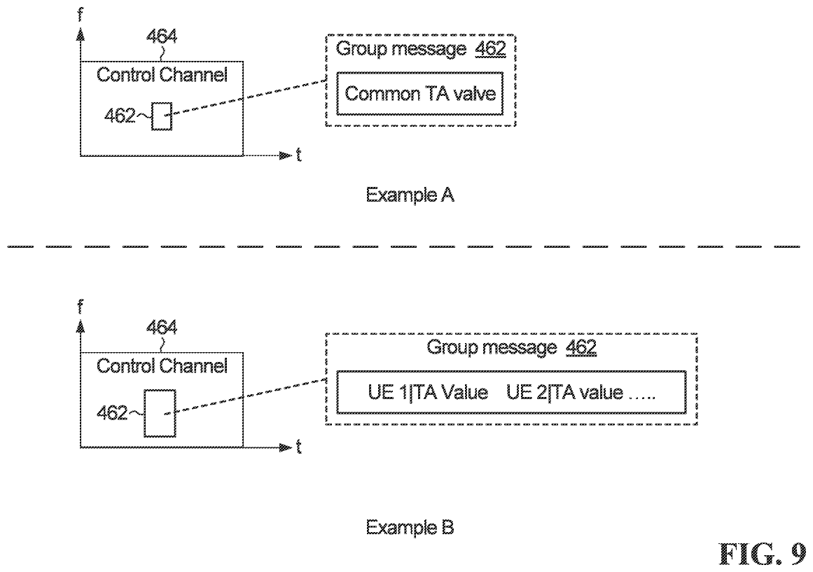

In some embodiments, TA-related information carried in a group message sent in physical layer control signaling may include an explicit indication of one or more TA values for one or more UEs in the group. For example, the TA-related information may include an indication of a common TA value to be used by some or all UEs in the group. As another example, the TA-related information may include an indication of a respective TA value for each of one or more UEs in the group, with a UE ID used to identify which TA value belongs to which UE. FIG. 9 illustrates two examples in which the group message directly indicates one or more TA values. In Example A of FIG. 9, a group message 462 sent in physical layer control signaling in a control channel 464 directly indicates a common TA value for all UEs in the group. The CRC of the physical layer control signaling may be scrambled using the group ID. Example B of FIG. 9 is a variation in which the group message 462 instead includes a respective TA value for each of one or more UEs in the group, each TA value being paired with an associated UE ID that indicates the UE to which the TA value belongs.

The benefit of indicating the TA values directly in the group message (like in FIG. 9) is that it allows for one or more TA values to be indicated dynamically in the control channel in physical layer control signaling. However, the drawback is possible higher overhead of the control signaling. Also, the physical layer control signaling is often limited in how much information (e.g. how many bits) it can directly transmit, which may impede the ability to provide the TA value(s) directly.

Therefore, in other possible embodiments, the TA-related information in the group message may instead be or include an indication of a time-frequency resource in a data channel at which a TA message is located. The TA message in the data channel then includes the one or more TA values for one or more UEs in the group. A UE in the group, e.g. UE 110, may then first decode the TA-related information in the group message sent in the physical layer control signaling in order to obtain an indication of the time-frequency location of the TA message in the data channel. The UE 110 may then decode the TA message at the indicated time-frequency location in the data channel in order to obtain a TA value. The data channel may be a physical downlink shared channel (PDSCH). The one or more TA values transmitted in the TA message in the data channel may include a common TA value to be used by some or all UEs in the group. As another example, the one or more TA values may include an indication of a respective TA value for each of one or more UEs in the group, with a UE ID used to identify which TA value belongs to which UE. The TA message in the data channel may possibly carry other information for one or more UEs. Examples of other information include: information associated with timing advance or synchronization, such as a timing reference point (e.g., base station, drone, satellite node, a reference node, a relative timing point, etc.), and/or beam direction/orientation configuration information, and/or downlink/uplink or uplink/downlink switching time, and/or other offsets associated with the round trip propagation delay for a UE; SCS information; carrier frequency band information; beam orientation and/or selection information, e.g. for beamforming for reception from base station and/or for beamforming for UE transmission; an indication of actions to be taken by the UE (e.g. an instruction to transition to a higher power mode); etc. In some embodiments, if the one or more TA values are instead transmitted in the physical layer control signaling, then some or all of the other information may also be transmitted in the physical layer control signaling.

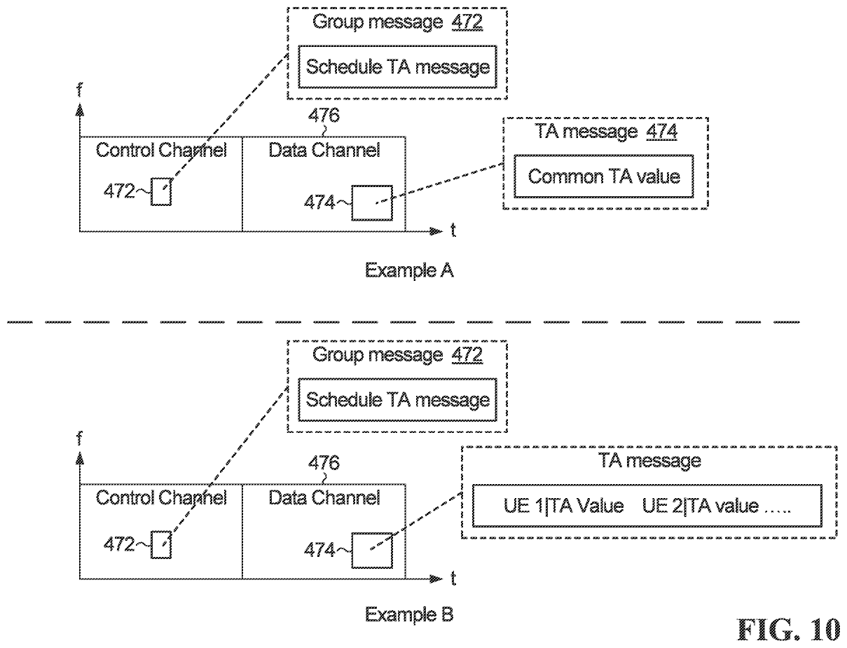

FIG. 10 illustrates two examples in which TA-related information in a group message 472 in the physical layer control signaling schedules a TA message 474 in a data channel 476, e.g. by the TA-related information indicating the time-frequency location of the TA message 474 in the data channel 476. In Example A of FIG. 10, the TA message 474 includes a common TA value for all UEs in the group. Example B of FIG. 10 is a variation in which the TA message 474 instead includes a respective TA value for one or more UEs in the group, each TA value being paired with an associated UE ID that indicates the UE to which the TA value belongs. In both examples, the TA message 474 may include other information for one or more of the UEs in the group, e.g. information related to timing advance and/or other information described in the paragraph above. Moreover or alternatively, some or all of the other information may be included in another message transmitted in the data channel 476 (e.g., PDSCH) and/or in information transmitted in the control channel.

Which example scenario in FIGS. 9 and 10 is implemented may be predefined or configured for the group of UEs. If configured, the configuration may occur via dynamic physical layer control signaling (e.g. DCI) or via higher layer signaling (such as RRC signaling) or a MAC CE. As one example, RRC signaling may configure the transmission of the group message as shown in Example A of FIG. 9 or Example B of FIG. 9 or Example A of FIG. 10 or Example B of FIG. 10.

In some embodiments, all UEs in the group operate in a default power saving state and each wake up during a respective wake-up duration to receive the group message in downlink physical layer control signaling. The wake-up duration of each UE overlaps with the wake-up duration of each other UE in the group, at least at the point in time at which the group message is transmitted. For example, each UE in the group may have the same wake-up durations 402 of FIG. 7. In some embodiments, a group message might not be transmitted in every wake-up duration. In some embodiments, a particular UE in the group might not need to receive a TA value via the group message by configuration or based on the scenario, e.g. if that UE has not moved. In some embodiments, a UE in the group may receive signaling (e.g. in a downlink notification in downlink control signaling at the start of a wake-up duration) indicating whether there is a group message to be transmitted in a particular wake-up duration and/or indicating whether the UE needs to obtain a TA value transmitted via a group message sent in a particular wake-up duration. If the UE does not need to obtain the TA value, then the UE does not need to decode the group message, which helps save UE power.

If a common TA value is transmitted to the group of UEs, then operation may proceed as follows in some embodiments. A plurality of UEs are grouped together, e.g. based on their close physical proximity to each other and/or based on the UEs having similar propagation delays or similar TA values. The base station 170 may establish the group and transmit the group ID to each UE in the group. The base station 170 then determines a common TA value for all UEs in the group. Different ways to determine the common TA value are possible. In one example, the base station 170 determines the TA value for each UE in the group, e.g. using the position of that UE or a UTS from the UE, and then selects the common TA value as the average or median of the TA values of the UEs in the group. In another example, the base station 170 selects the common TA value as the TA value corresponding to a representative position or propagation delay in the group. In any case, a group message having TA-related information is then sent to the group of UEs in physical layer control signaling. The TA-related information may indicate the common TA value directly (like Example A of FIG. 9). Alternatively, the TA-related information may indicate a time-frequency resource in the data channel at which a TA message is located, and the TA message in the data channel carries the common TA value (like Example A of FIG. 10). Each UE in the group decodes the group message and ultimately obtains the common TA value, either directly from the group message, or from a TA message in the data channel at a time-frequency location indicated by the group message. The common TA value may be updated over time, e.g. as the group of UEs move, and the updated common TA value may be transmitted to the group of UEs. The points at which the common TA value is updated may be periodic, preconfigured, or on an as-needed basis based on the movement of the group of UEs. Moreover, the UE grouping for receiving the TA-related information can change over time, that is, regrouping of UEs to receive the TA-related information is possible.

In implementations that do not utilize a common TA value, but instead indicate a respective TA value for each of one or more UEs in a group, the operation may proceed as follows in some embodiments. UEs are grouped together, e.g. based on their physical proximity to each other, such as UEs in a same region. The base station 170 may establish the group and transmit the group ID to each UE in the group. The base station 170 then determines a respective TA value for each UE in the group that needs its TA value updated. A group message having TA-related information is then sent to the group of UEs in physical layer control signaling. The TA-related information may directly indicate the respective TA value for each UE in the group that requires an updated TA value (like Example B of FIG. 9). Alternatively, the TA-related information may indicate a time-frequency resource in the data channel at which a TA message is located, and the TA message includes a respective TA value for each UE in the group that requires an updated TA value (like Example B of FIG. 10). In any case, each TA value may be associated with a particular UE in the group using an identifier that uniquely identifies the UE, e.g. a UE ID. A UE in the group decodes the group message to ultimately obtain its TA value, either directly from the group message or by decoding the TA message in the data channel at the time-frequency location indicated in the group message. Also, each TA value may be an absolute TA value or a relative TA value. Some UEs in a group may receive an absolute TA value, and other UEs in the same group may receive a relative TA value. Not every UE may need to have its TA value updated each time a group message is transmitted. For example, if one UE in the group is moving faster than another UE in the group, then the UE moving faster may need to have its TA value updated more often. The base station 170 may determine, for each UE in the group, whether that UE requires an updated TA value, e.g. using a table such as table 432 in memory. For a particular group message, updated TA values might only be sent for the UEs in the group needing their TA value updated. In some embodiments, a UE in the group may receive signaling indicating whether there is an updated TA value for that UE to be transmitted via an upcoming group message. For example, the signaling may be downlink physical layer signaling sent at the start of the wake-up duration, where the group message is being transmitted by the base station 170 during that wake-up duration. If there will be no updated TA value for the UE, then the UE does not decode the group message, which may save UE power.

Regardless of which of the examples in FIGS. 9 and 10 are implemented, when a UE receives a TA value in a group message, in some embodiments the UE may subsequently receive an updated TA value, e.g. in a unicast message, rather than in a group message. The updated TA value may be directly indicated in a unicast message in physical layer control signaling (e.g. in DCI), or the unicast message in physical layer control signaling may schedule a unicast TA message in a data channel (e.g. a PDSCH), where the unicast TA message in the data channel carriers the updated TA value. In one example implementation, a unicast message sent in physical layer control signaling has its CRC scrambled using the UE ID of the UE for which the unicast message is meant, e.g. the physical layer control signaling is or includes DCI that is used to generate the CRC, and then the CRC is scrambled by the UE ID. The UE unscrambles the CRC, and decodes the unicast message to either receive the updated TA value directly (e.g. if the TA value is indicated in the control information), or to receive an indication of a time-frequency location at which a TA message indicating the TA value is located. In any case, the updated TA value may be in the form of an adjustment that is to be applied to the TA value received via the group message, in order to try to result in a more accurate TA value for the UE. For example, the UE may receive a common TA value in a group message, and then subsequently receive an updated TA value in a unicast message in the form of an adjustment to be applied by that UE to the common TA value. Different UEs in the group may receive different adjustments. In some embodiments, the updated TA value is determined using a position of the UE. In some embodiments, the updated TA value is determined using a UTS transmitted by the UE. In some embodiments, a UE in the group may be predefined or preconfigured to receive an updated TA value. In some embodiments, the TA message for the group that is sent in the data channel, or the physical layer control signaling carrying the TA-related information, may include an indication as to whether a UE in the group is to subsequently receive an updated TA value in a unicast message. The time and/or frequency location for transmitting a UTS and/or for receiving the updated TA value in the unicast message may be configured. The configuration may be indicated in the TA message, in TA-related information, or separately, e.g. using physical layer signaling (such as DCI) or higher layer signaling (such as RRC signaling). In some embodiments, beam orientation information for a UE may be transmitted together with the updated TA value.

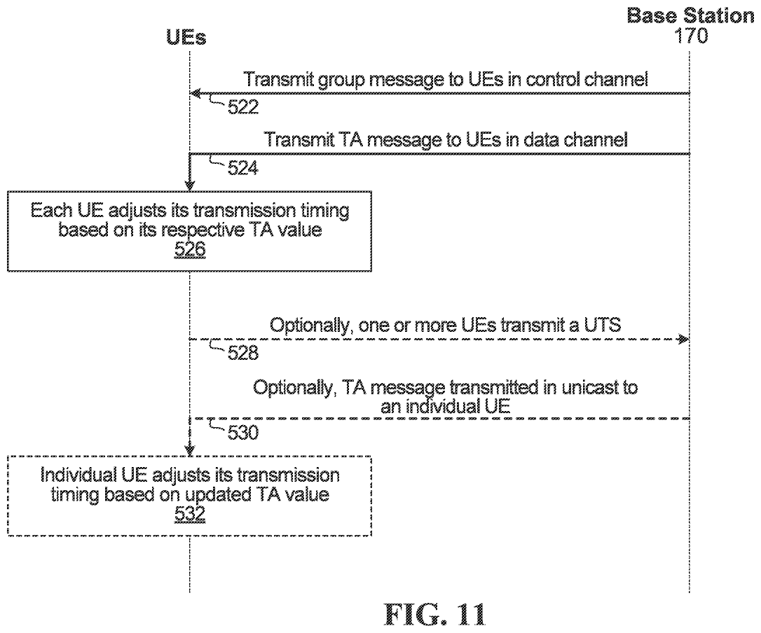

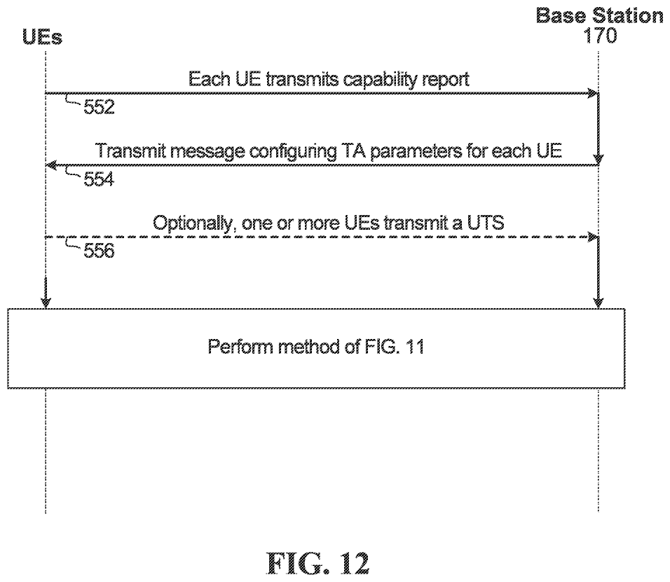

FIG. 11 illustrates a method performed by a base station 170 and a plurality of UEs in a group, according to one embodiment. At step 522, the base station 170 transmits a group message to the UEs in a control channel. The group message indicates a time-frequency location in a data channel at which a TA message is located. Each UE decodes the group message to determine the time-frequency location of the TA message in the data channel. At step 524, the base station 170 transmits the TA message at that time-frequency location in the data channel. The UEs decode the TA message. The TA message includes a respective TA value for each UE, e.g. like in Example B of FIG. 10. At step 526, each UE adjusts its uplink transmission timing based on its respective TA value in the TA message. Optionally, at step 528, one or more of the UEs each send a respective UTS to the base station 170. A UE transmitting a UTS in step 528 may apply a time offset to the uplink transmission of the UTS using the TA value received in step 526. For at least one of the UEs sending a UTS, the base station 170 uses the received UTS from the UE to determine the uplink timing of the UE and thereby determine an updated TA value. The updated TA value may be a relative TA value in the form of an adjustment/refinement to apply to the TA value received at step 526. At step 530, the updated TA value is optionally sent to that UE in a unicast message, e.g. in physical layer control signaling (such as DCI), and at step 532 the UE adjusts its transmission timing based on the updated TA value. In some embodiments, a UE may also receive additional information in the TA message sent in step 524 and/or in the unicast TA message sent in step 530. For example, a UE may also receive beam update information, such as an indication of an updated beam direction (e.g. beam angle) for transmit and/or receive beamforming, in which case the UE may also update its transmit and/or receive beam based on the beam update information. Furthermore or alternatively, the TA message may be transmitted in unicast to an individual UE in step 530 by transmitting a unicast downlink control signaling to the UE scheduling a time-frequency resource for a data channel and the TA message for the UE being transmitted in the data channel.

FIG. 12 illustrates a method performed by a base station 170 and a plurality of UEs, according to another embodiment. At step 552, each UE transmits a capability report to the base station 170. In some embodiments, the capability report for a UE is sent by that UE upon initial entry into the network. In a capability report, a UE may indicate the UE's capabilities, such as the UE's modulation and coding scheme (MCS), frequency band(s) of operation, beam capability information, beam measurement information, etc. In some embodiments, the capability report may indicate whether the UE has the ability to transmit a UTS and/or may indicate restrictions relating to the UTS (e.g. the UTS must be a preamble). In some embodiments, the capability report indicates whether the UE supports group TA adjustments, i.e. a TA adjustment sent in or via a group message, such as per the examples in FIGS. 9 and 10. In some embodiments, in the capability report the UE provides information used by the base station 170 to determine when to provide TA updates, e.g. the UE may indicate that it is stationary, slow moving, possibly fast moving, etc. For example, if the UE indicates that it is stationary, then the TA value for the UE may rarely be updated. In some embodiments, in the capability report the UE may indicate how often it may or should require a TA adjustment, e.g. the UE may indicate or suggest that a TA adjustment occur once every 5 seconds. In some embodiments, recommended or suggested values (or range of values) for TA parameters and/or UTS and/or beam measurement information may be provided. For example, the UE may indicate a range of TA values to the base station 170, which the base station 170 refines to a more specific TA value for that UE. Step 552 may occur before or after the UE is assigned to a group.

Based on the capability of each UE, at step 554 the base station 170 transmits a message to the group of UEs, the message configuring TA-related parameters for each of one, some, or all of the UEs in the group. The TA related parameters may possibly include a TA ID (e.g., TA-RNTI) for a group of UEs (i.e., a group ID for TA reception) The message may be a group message, or it may be a unicast message respectively sent to each UE requiring a TA-related parameter to be configured. The message may be in physical layer control signaling or in a data channel. In some embodiments, the message sent in step 554 may include an indication of whether the UE is to operate in a power saving state and/or in a default operating mode (e.g. low power mode), and if so, the message sent in step 554 may indicate parameters (e.g. TA-related parameters) the UE is to utilize in that state or mode. In some embodiments, the message sent in step 554 may include an indication of whether a UE is to send a UTS and if so, the message may include a configuration related to the UTS, e.g. when/how often the UTS is to be transmitted, the time and/or frequency resource at which the UTS is to be transmitted, the type of UTS (e.g. preamble or another signal), possibly the content of the UTS, etc. In some embodiments, the message transmitted in step 554 may include a configuration of the time-frequency resource at which the group message carrying the TA-related information is to be received, e.g. possibly including how often the UE is to monitor for the group message, which is referred to as the monitoring occasion (e.g., the message may include wake-up and DRX parameter configurations). In some embodiments, the message transmitted in step 554 may include an indication of a group the UE is in and/or may indicate the group ID assigned for the group the UE is in. The configuration message transmitted in step 554 can be transmitted in semi-static or dynamic signaling, e.g., via RRC or DCI signaling.

Optionally, at step 556, one or more of the UEs each send a respective UTS to the base station 170. For at least one of the UEs sending a UTS, the base station 170 uses the received UTS from the UE to determine the uplink timing of the UE and thereby determine a TA value for the UE.

The steps explained in relation to FIG. 11 are then performed.

In some embodiments, recommended or suggested values (or range of values) for TA parameters and/or UTS and/or beam measurement information may be provided by system information. For example, a range of TA values are broadcast in synchronization signal block (SSB) bursts, especially common TA parameters such as default TA monitoring parameter and TA associated PDCCH time and frequency resources.

The ways in which a group is established may be configurable. For example, grouping criteria may be based on UEs that are co-located in a vicinity. In some embodiments, grouping is based on UE proximity, e.g. UEs in same bus, same train compartment, etc. are grouped together, which is related to individual UE positioning. In some embodiments, if beamforming is implemented, grouping may be based on UEs in a same beamforming cluster area. However, UEs belonging to a same beam cluster might not have a similar distance to the base station. In some embodiments, grouping may be based on UE category, such as UEs having a similar level of mobility. In some embodiments, non-narrow beam or wide beam transmission is used for TA monitoring or/and wake-up period configuration as well as the TA-related information transmission. In some embodiments, grouping may be based on UEs requiring a similar TA monitoring occasion, e.g. UEs requiring a TA value update at a similar frequency, e.g. UEs travelling the same speed. For example, slower UEs may be grouped together in one group and faster UEs may be grouped together in a different group. In some embodiments, UE grouping is based on sidelink (i.e. device-to-device) range measurement.

TA groups (TAGs) are discussed earlier. In some embodiments, a UE in a group may receive one or more TA values for its different TA groups, e.g. if the UE communicates with multiple base stations that are part of different TA groups.

In some embodiments, a UTS may be transmitted to the base station 170 by one or more UEs in a group, e.g. if the base station 170 is unable to accurately estimate the RTT for the one or more UEs, e.g. if the UEs are behind a building. The UTS may be a preamble that allows for computation of the TA value. A respective TA value for each UE sending a UTS may be computed. The TA values may then be transmitted in a group message or in unicast messages.

In some embodiments, the granularity of a TA adjustment via a group message may be configurable. In some embodiments, the amount/quantity of TA adjustment that can be indicated via a group message may be configurable. In some embodiments, the periodicity of the group message may be configurable. For example, the group message may be configured to be received in every wake-up period of a DRX cycle, or every other wake-up period, etc. In some embodiments, one, some, or all of the UEs in a group may be configured to receive one TA value or more than one TA value during a wake-up window of a DRX cycle. In some embodiments, a group of UEs may be configured to receive one or more group messages and/or one or more TA messages during a wake-up window of a DRX cycle. Any configurations described herein may be configured via higher layer signaling (e.g. RRC signaling or MAC CE) or in physical layer signaling (e.g. DCI). In some embodiments, the base station may apply wide beam transmissions to the group of UEs.

Using a group message, e.g. as described in embodiments above, may reduce overhead base station control signaling and/or power usage compared to unicast signaling because a single group message is sent, rather than individual unicast messages.

### Providing a TA Value Via a Unicast Message

In some embodiments, a unicast message carrying TA-related information may be sent to a UE, e.g. UE 110, in physical layer control signaling. The UE 110 might or might not be part of a group of UEs. The unicast message may have its CRC masked (e.g. scrambled) using the UE ID of UE 110. For example, the unicast message may be or include physical layer control information, e.g. DCI, that is used to generate a CRC, and the CRC is then scrambled by the UE ID. UE 110 may perform blind decoding on a control channel with unmasking using its UE ID, e.g. by unscrambling the CRC using the UE ID by performing an XOR operation between the masked CRC and the UE ID. When unmasking using the UE ID is successful (e.g. the unscrambled CRC results in a correct CRC value match), then the message may be decoded by the UE. The contents of the message may include TA-related information.

In some embodiments, the TA-related information carried in a unicast message that is sent to UE 110 in physical layer control signaling may include an explicit indication of a TA value for the UE 110. For example, a TA value may be computed by the base station 170 for UE 110, e.g. using the position of the UE 110 and/or a UTS received from the UE 110. The TA value may then be transmitted to the UE 110 in the unicast message in the physical layer control signaling, e.g. the TA value may be part of DCI. The UE 110 decodes the physical layer control signaling to decode and obtain the TA value. The benefit of indicating the TA value directly in the physical layer control signaling is that it allows for a TA value to be indicated dynamically in the control channel in the physical layer control signaling. For example, the TA value may be indicated in a few bits in a TA field in physical layer control information, e.g. in DCI. As another example, the TA value may be provided along with a scheduling grant, e.g. the base station 170 sends, to UE 110, DCI scheduling an uplink or downlink transmission for UE 110, and the DCI also includes a TA value (e.g. an updated TA value) for the UE 110. The possible drawback of indicating a TA value directly in the physical layer control signaling is possible higher overhead of the control signaling. Also, the physical layer control signaling is often limited in how much information (e.g. how many bits) it can directly transmit, which may impede the ability to provide the TA value directly.

Therefore, in other possible embodiments, the TA-related information in the unicast message sent to the UE 110 in the physical layer control signaling may instead be or include an indication of a time-frequency resource in a data channel at which a TA message is located. The TA message in the data channel is dedicated to the UE 110 and includes the TA value for UE 110. The TA message may include the UE ID for UE 110. In operation, the UE 110 first decodes the TA-related information in the unicast message sent in the physical layer control signaling in order to obtain an indication of the time-frequency location of the TA message in the data channel. The UE 110 may then decode the TA message at the indicated time-frequency location in the data channel in order to obtain its TA value from the base station 170. The data channel may be a PDSCH. The TA message in the data channel may possibly carry other information for UE 110. Examples of other information include: information associated with timing advance or synchronization, such as a timing reference point (e.g., base station, drone, satellite node, a reference node, a relative timing point, etc.), and/or beam direction/orientation configuration information, and/or downlink/uplink or uplink/downlink switching time, and/or other offsets associated with the round trip propagation delay for UE 110; SCS information; carrier frequency band information; beam orientation and/or selection information, e.g. for beamforming for reception from base station and/or for beamforming for UE transmission; an indication of actions to be taken by the UE (e.g. an instruction to transition to a higher power mode); etc. If the TA value is indicated in the physical layer control signaling, rather than in a data channel, then in some embodiments some or all of the other information may instead also be indicated in the physical layer control signaling.

Whether the TA value for UE 110 is sent in the physical layer control signaling itself, or whether the TA value is sent in a data channel at a time-frequency location indicated in the physical layer control signaling, may be predefined or configured for UE 110. If configured, the configuration may occur via dynamic physical layer control signaling (e.g. DCI) or via higher layer signaling (such as RRC signaling) or a MAC CE.

Configuring and indicating TA values on a UE-by-UE basis in unicast messages may result in more control/overhead compared to using a group message described earlier. However, the possible benefit is as follows: configuration may be optimized on a UE-by-UE basis. For example, TA monitoring occasions (e.g. when and how often a UE is to monitor for TA-related information in the physical layer control signaling), and/or other parameters associated with timing advance or synchronization, may be customized to the UE. For example, if one UE is mostly static/slow moving, then the base station 170 may configure TA monitoring occasions to be far apart, e.g. one per DRX wake-up duration, or one every few DRX wake-up durations, which allows for that UE to save power by monitoring for the TA-related information less often. If another UE is fast moving, then the base station 170 may configure TA monitoring occasions to be more often, e.g. shorter DRX cycle or wake up periodicity, to ensure the TA value remains valid.

In some embodiments, the unicast message carrying the TA-related information may be transmitted periodically, e.g. at predefined or configured TA monitoring windows or instants. In other embodiments, the unicast message carrying the TA-related information may be transmitted on demand.

TA groups (TAGs) are discussed earlier. In some embodiments, UE 110 may receive, via the unicast message, a respective TA value for each of its different TA groups, e.g. if the UE 110 communicates with multiple base stations that are part of different TA groups.

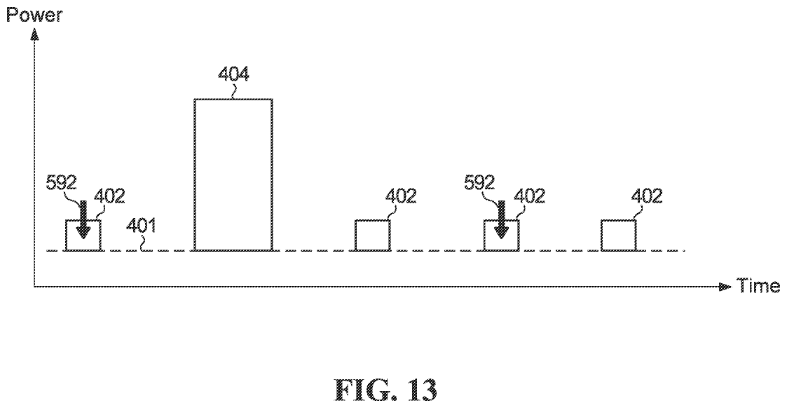

In some embodiments, the periodicity at which a TA value is sent to UE 110, referred to as the TA messaging periodicity, may be configured for UE 110, e.g. using dynamic signaling (e.g. DCI) or higher layer signaling, such as RRC signaling, or a MAC CE. For example, the TA messaging periodicity may be configured as one or more periods of a DRX cycle. In some embodiments, a TA value may be sent on demand in any of the wake-up instants of UE 110 in a DRX cycle. FIG. 13 illustrates power consumption for the UE 110 when operating in a single power-saving state, according the embodiment in FIG. 7. However, FIG. 13 further illustrates example times at which the UE 110 is configured to receive a TA value. Specifically, each arrow 592 represents a downlink notification in a wake-up duration 402. In the downlink notification, the UE 110 is to receive a unicast message carrying TA-related information. The TA-related information may carry the TA value itself, or the TA-related information may carry an indication of a time-frequency location in a data channel at which the TA value is located. In general, the TA-related information may be received from the base station 170 either periodically or as needed, e.g. in every one or more wake-up cycles (or DRX cycles). In general, the UE 110 may receive one or more unicast messages carrying TA-related information during a wake-up window in a DRX cycle or other configured time slot. In the example in FIG. 13, the unicast message carrying TA-related information is not transmitted in every wakeup duration.

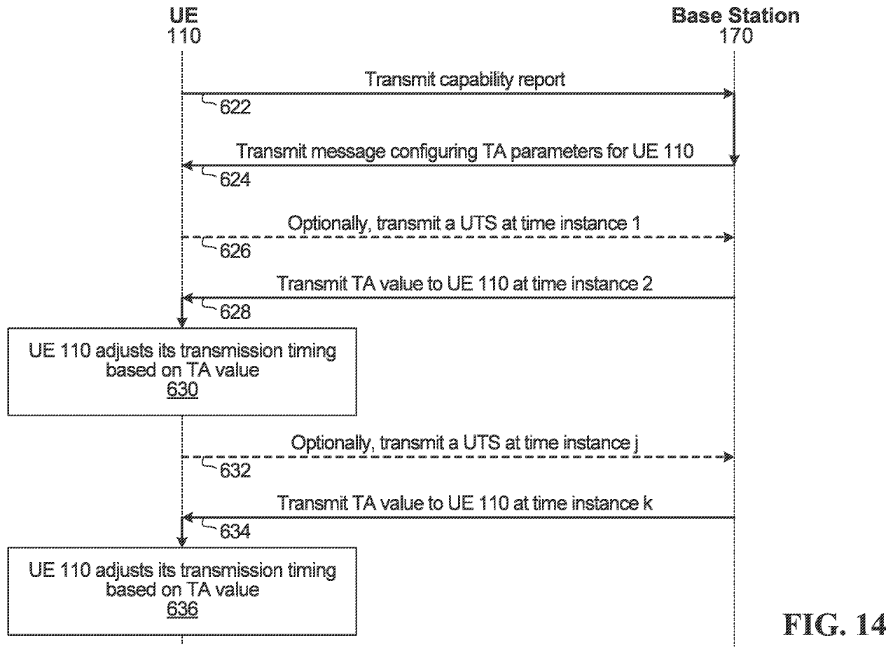

FIG. 14 illustrates a method performed by a base station 170 and a UE 110, according to one embodiment. At step 622, UE 110 transmits a capability report to the base station 170. In some embodiments, the capability report is sent upon initial entry into the network. In the capability report, the UE 110 may indicate its capabilities, such as the UE's MCS frequency band(s) of operation, beam capability information, beam measurement information, etc. In some embodiments, the capability report may indicate whether the UE 110 has the ability to transmit a UTS and/or may indicate restrictions relating to the UTS (e.g. the UTS must be a preamble). In some embodiments, the capability report provides information used by the base station 170 to determine when to provide TA value updates, e.g. the UE 110 may indicate that it is stationary, slow moving, possibly fast moving, etc. For example, if the UE 110 indicates that it is stationary, then the TA value for the UE 110 may rarely be updated. In some embodiments, in the capability report the UE 110 may indicate how often it may or should require a TA adjustment, e.g. the UE 110 may indicate or suggest that a TA adjustment occur once every 5 seconds. In some embodiments, recommended or suggested values (or range of values) for TA parameters and/or UTS and/or beam measurement information may be provided. For example, the UE 110 may indicate a range of TA values to the base station 170, which the base station 170 refines to a more specific TA value for that UE 110.

Based on the capability of UE 110, at step 624 the base station 170 transmits a message to UE 110 configuring TA-related parameters for the UE 110. The message may be a unicast message in physical layer control signaling or in a data channel. In some embodiments, the message sent in step 624 may include an indication of whether the UE 110 is to operate in a power saving state and/or in a default operating mode (e.g. low power mode), and if so, the message sent in step 624 may indicate parameters (e.g. TA-related parameters) the UE 110 is to utilize in that state or mode. In some embodiments, the message sent in step 624 may include an indication of whether the UE 110 is to send a UTS and if so, the message may include a configuration related to the UTS, e.g. when/how often the UTS is to be transmitted, the time and/or frequency resource at which the UTS is to be transmitted, the type of UTS (e.g. preamble or another signal), possibly the content of the UTS, etc. In some embodiments, the message transmitted in step 624 may include a configuration of the time-frequency resource at which the unicast message carrying the TA-related information is to be received, e.g. possibly including how often the UE is to monitor for the TA-related information, which is referred to as the monitoring occasion. The configuration message transmitted in step 624 can be transmitted in semi-static or dynamic signaling, e.g., via RRC or DCI signaling.

Optionally, at step 626, the UE 110 sends a UTS to the base station 170 at time instance 1. The base station 170 may use the UTS from the UE to determine the uplink timing of the UE 110 and thereby determine a TA value for the UE 110. If the UTS is not transmitted, the TA value for the UE 110 may be determined in another manner, e.g. based on the position of the UE 110.

At step 628, the base station 170 transmits a TA value to the UE 110 at a time instance 2. The TA value may be transmitted in the different manners described above. For example, the base station 170 may transmit a unicast message for UE 110 in physical layer control signaling. The unicast message includes TA-related information. The TA-related information is either a TA value, or an indication of a time-frequency location in a data channel at which the TA value is located. At step 630, the UE 110 adjusts its uplink transmission timing based on the TA value received at step 628. Optionally, at step 632, the UE 110 transmits a UTS to the base station 170 at a later time instance j. The UE 110 may apply a time offset to the uplink transmission of the UTS using the TA value received in step 628. The base station 170 may use the UTS from the UE to determine updated uplink timing for the UE 110 and thereby determine an updated TA value for the UE 110. If the UTS is not transmitted, an updated TA value for the UE 110 may be determined in another manner, e.g. based on the position of the UE 110.

At step 634, the base station 170 transmits the updated TA value to the UE 110 at a time instance k. The updated TA value may be transmitted in the different manners described above. For example, the base station 170 may transmit a unicast message for UE 110 in physical layer control signaling. The unicast message includes TA-related information. The TA-related information is either the updated TA value, or an indication of a time-frequency location in a data channel at which the updated TA value is located. The updated TA value may be an absolute or relative value, e.g. the updated TA value may be a relative value indicating a timing adjustment relative to the TA value transmitted in step 628. In some embodiments, the updated TA value may be transmitted in step 634 in response to the timing error exceeding a certain threshold, e.g. getting close to timing error limit Tₑ. At step 636, the UE 110 adjusts its uplink transmission timing based on the updated TA value received at step 634.

In some embodiments in the method of FIG. 14, the UE 110 may also receive additional information at step 628 and/or at step 634. For example, the UE 110 may also receive beam update information, such as an indication of an updated beam direction (e.g. beam angle) for transmit and/or receive beamforming, in which case the UE 110 may also update its transmit and/or receive beam based on the beam update information.

### Uplink Touch Signal (UTS)

An UTS is described in some embodiments above. Transmission of an UTS may be optional, but if it is transmitted by a UE, then the UTS may be used in determining the TA value for a UE. As mentioned earlier, a UTS might be one or more of the following: a preamble; a dedicated uplink synchronization signal; a sounding signal; a sounding reference signal (SRS); a sensing signal; a measurement report (such as a radio resource management (RRM) measurement report); a positioning report; a sensing report; a demodulation reference signal (DMRS); uplink data or traffic; an uplink pilot (which may be a preamble, a measurement pilot/reference signal, a demodulation pilot/reference signal); range/distance measurements from a reference position. The timing of the uplink transmission may be determined from the UTS to obtain the TA value, e.g. in the same way a preamble is used to determine the TA value, and/or the content in the UTS itself (e.g. an indication of the position of the UE relative to the base station 170) may be used to determine the TA value. In some embodiments, the UTS is a RACH preamble, but the TA value might or might not be provided in a random access response (RAR) message.

In some embodiments, a UTS may be optionally transmitted by UE 110 and used by the base station 170 only in particular scenarios. For example, the position of the UE 110 may be determined by the base station 170 and primarily used by the base station 170 to determine a TA value for the UE 110. However, if the UE 110 is fast moving or has a sudden change in movement (e.g. goes from slow moving to fast moving), then the UE 110 may transmit a UTS to the base station 170 for use by the base station 170 to refine the TA value for the UE 110.

More generally, in some embodiments a UTS may be used by the base station 170 in addition to positioning info of a UE 110, e.g. for more enhanced/accurate TA value computation or refinement, etc. In other embodiments the UTS might not be sent or used at all. In other embodiments, the UTS might be all that is used for TA value computation by the base station 170. In some embodiments, a UTS is sent when the UE 110 is fast moving or on demand with some predefined or configured conditions.

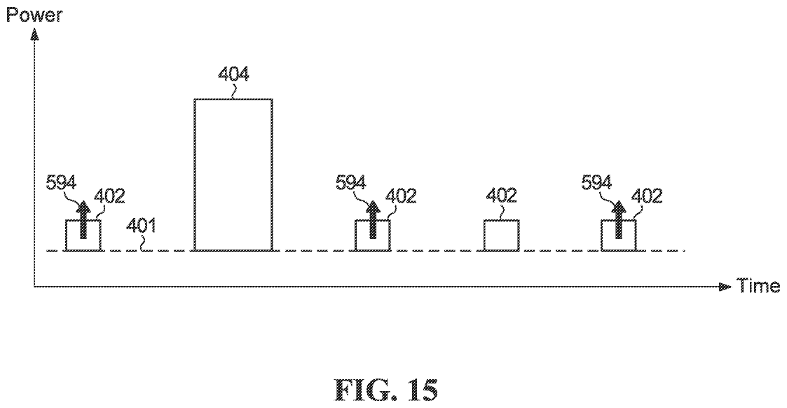

If a UTS is transmitted by a UE 110 and used by the base station 170 in computation of a TA value, the UTS does not necessarily need to be sent in every DRX wake-up duration. For example, FIG. 15 illustrates power consumption for the UE 110 when operating in a single power-saving state, according the embodiment in FIG. 7. However, FIG. 15 further illustrates example times at which the UE 110 is configured to transmit a UTS. Specifically, each arrow 594 represents an uplink transmission in a wake-up duration 402 during which the UE 110 is to transmit a UTS to the base station 170. In the example in FIG. 15, a UTS is not transmitted in every wake-up duration 402. The base station 170 may compute a TA value based on the UTS and transmit the TA value to the UE 110, e.g. in or via a downlink notification in a subsequent wake-up duration. The times at which a UTS is transmitted may be predefined or preconfigured, e.g. the UE 110 may be configured to send a UTS once in every one or more wake-up cycles, or on demand based on a request from the base station 170, etc.

In some embodiments, a UTS is sent when in a power-saving state, and possibly only at predefined or (pre)configured locations or conditions, e.g. like explained above in relation to FIG. 15. In one example, the UE 110 transmits a UTS (e.g. a SRS or sensing signal) at a time instance before a DRX on period, or at the beginning of a DRX on period.

In some embodiments, UE 110 may send a UTS based on a synchronization timer (ST). For example, when the ST expires (and returns back to zero to start recounting), then the UE 110 sends a UTS. The base station 170 may be able to configure the ST in the UE 110, e.g. change its expiry value to have a UTS transmitted less often or more often. In some embodiments, instead of or in addition to a ST, there may exist other trigger conditions for sending a UTS, e.g. a UTS may be transmitted after receiving a group message (e.g. as per step 528 of FIG. 11) to be used for TA refinement.

In some embodiments, it may be determined how often to send a UTS (or more generally update a TA value) based on certain criteria, e.g. criteria such as keeping uplink timing error for the UE within the required timing error limit for different scenarios (e.g. for certain carrier frequency bands, SSB SCS, data channel SCS, etc.). Configuration of the UE 110 may be based on different factors, which may possibly control when a UTS is sent. Factors may include: mobility status, e.g., the UE 110 is static, slow moving, fast moving, etc.; moving speed and direction, e.g., a UTS is sent more often if the UE 110 is fast moving; UE 110 transmit and receive beam directions, e.g., if UE transmit and receive beams have different directions; RRM measurements the UE 110 can support and/or UE capability on measurement, e.g. the RRM measurement may be associated with a UTS, e.g., RRM measurement reporting, including beam measurement reporting info may be a factor; configuration of a synchronized timer (ST). The ST value may be configured semi-statically and/or dynamically. The ST value may be configured to be associated with a DRX cycle, or it may be configured to be independent of a DRX cycle. The ST may be updated or reconfigured once the UE mobility status changes.

### Additional Variations and Methods

Communication between UE 110 and base station 170 is assumed in many of the embodiments above. However, the embodiments also apply to communication between a UE 110 and a relay node (e.g. an integrated access and backhaul (IAB) node, or a base station relaying data from satellite, etc.), where the timings to a relay node (e.g., satellite node) and a base station can be quite different due to dramatically different distances to them from the UE For an embodiment involving a relay node, a compensation period for the relay/switching delay may need to be factored into the uplink timing. The embodiments also apply to communication between a UE 110 and any network node. A network node may be a fixed base station, a moving base station, a relay base station (such as IAB, either fixed or moving), etc. The network node may be in an integrated terrestrial and non-terrestrial network. The network node may be a satellite, a drone, unmanned aerial vehicle (UAV), etc. A network node that is a ground base station may be a relay node, e.g. if communication with the network is via a satellite. In this case, a TA value for a UE may be based on a reference point in the network between the UE and the reference point, then any additional propagation time offset and/or relaying/switching delay over a communication path (or an accumulated overall time offset incurred in operation) may be indicated at least by one additional parameter (e.g., other timing offset) to allow for timing synchronization to work. For example, in one embodiment, the actual round trip timing (RTT) may become TA value to a reference point+other timing offset(s) incurred by the other node(s) communicating to the reference point.

Embodiments herein are not just applicable to a UE operating in a power saving state or mode, but may also be implemented in other scenarios, e.g. when the UE is in the process of handing over.

As discussed earlier, the embodiments do not just apply to synchronizing uplink communications, but are applicable to any scenario in which a TA value is used for the time synchronization of transmissions. Uplink transmissions by a UE are what are discussed in many of the example embodiments herein, but TA values could be used for transmissions between UEs (e.g. over a sidelink), transmissions between network devices (e.g. over a backhaul link), transmissions to/from a satellite or a drone, etc.

Various examples are described earlier in which certain parameters can be configured for the UE 110, e.g. TA-related parameters. Any configuration described herein may be predefined or dynamically configured using physical layer control signaling (e.g. DCI) or semi-statically configured (e.g. using higher layer signaling such as RRC signaling, or a MAC CE, etc.). As one example, whether a TA refinement is to be performed for a UE (e.g. whether the UE 110 is to receive the TA update/refinement in step 530 of FIG. 11) may be semi-statically configured or dynamically configured, e.g. as part of the TA-related information. As another example, the particular time-frequency resource at which TA-related information is received may be predefined, or configured semi-statically or dynamically. If time-frequency resources for receiving TA-related information is configured, the following are example possibilities. The time-frequency resources may be located at monitoring time instants for a UE in a power-saving state. The time-frequency resources may have an association with a DRX cycle configuration, e.g. the monitoring time instant may be in every DRX_on period or in one in every multiple DRX_on periods. The time locations of the time-frequency resources may be at monitoring time locations, and the frequency location(s) of the time-frequency resources may be predefined or configured semi-statically or dynamically.

Other information, including information associated with timing advance or synchronization, is discussed herein, and may include information such as: a timing reference point (e.g., base station, drone, satellite node, a reference node, a relative timing point, etc.), and/or beam direction/orientation configuration information, and/or downlink/uplink or uplink/downlink switching time, and/or other offsets associated with the round trip propagation delay for a UE; SCS information; carrier frequency band information; beam orientation and/or selection information, e.g. for beamforming for reception from base station and/or for beamforming for UE transmission; an indication of actions to be taken by the UE (e.g. an instruction to transition to a higher power mode); etc.

In some embodiments, the timing offset applied by a UE 110 may be based on both the TA value from the base station and other information, e.g. such as any of the information associated with timing advance or synchronization described herein. In some embodiments, the other information may include system design parameters, such as downlink/uplink switching delay, e.g. to try to guarantee the signal processing and switching period for a relay UE or relay base station, or beam related information (on UE and/or network) to indicate which beam(s) to be used or how to adjust the beam direction for the UE Tx/Rx, etc. For example, the other information may be an indication of a beam direction. The UE 110 may then apply a timing offset based on the TA value and in the indicated beam direction.

Control information is discussed herein in some embodiments. In some cases, the control information may be dynamically indicated, e.g. in the physical layer in a control channel. An example of control information that is dynamically indicated is information sent in physical layer control signaling, e.g. downlink control information (DCI). Control information may sometimes be semi-statically indicated, e.g. in RRC signaling. Control information may sometimes be referred to as signaling. Dynamic indication may be an indication in lower layer, e.g. physical layer/layer 1 signaling, rather than in higher-layer semi-static signaling such as RRC signaling or in a MAC CE.

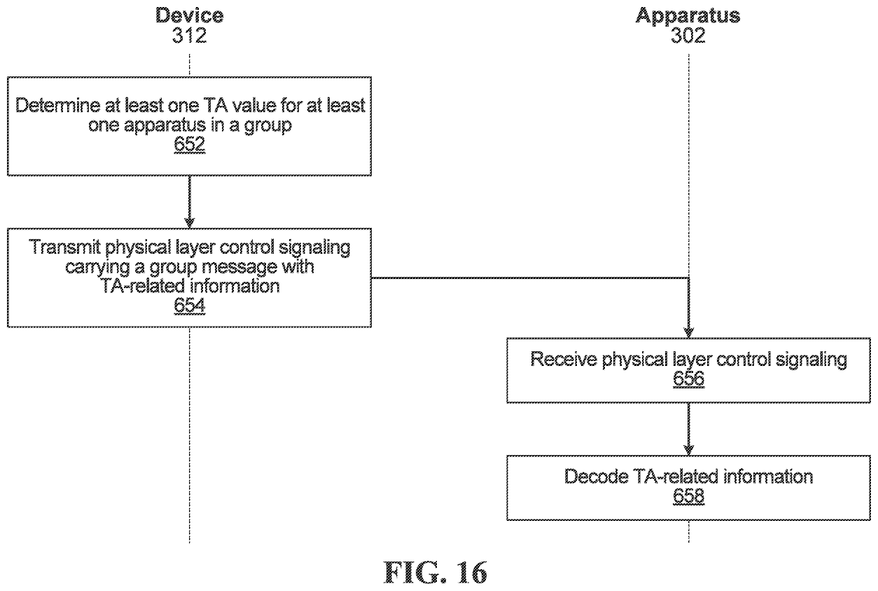

FIG. 16 illustrates a method performed by apparatus 302 and device 312, according to one embodiment. The apparatus 302 may be a UE, e.g. UE 110, although not necessarily. The device 312 may be a network device, e.g. base station 170, although not necessarily. The apparatus 302 is in a group of apparatuses.

At step 652, the device 312 determines at least one TA value for at least one apparatus in the group. In some embodiments, the at least one TA value may be or include a common TA value, e.g. a TA value that is common to some or all of the apparatuses in the group. In some embodiments, the at least one TA value may be or include a TA value that is specific to the apparatus 302.

At step 654, the device 312 transmits physical layer control signaling. The physical layer control signaling carries a group message for the group of apparatuses. The group message includes TA-related information. The TA-related information is associated with the at least one TA value, e.g. the TA-related information may indicate the at least one TA value or may indicate a time-frequency location in a data channel at which the at least one TA value is located. In some embodiments, the group message is associated with a group ID. In some embodiments, the physical layer control signaling includes a CRC that is scrambled using the group ID.

At step 656, the apparatus 302 receives the physical layer control signaling. At step 658, the apparatus 302 decodes the TA-related information.

From the perspective of the apparatus 302, the following may be possible in the method of FIG. 16.

In some embodiments, the at least one TA value is or includes a common TA value, and the method may further include: subsequent to receiving the common TA value, the apparatus 302 receives a unicast transmission that includes updated TA-related information for the apparatus 302. The method may further include the apparatus 302 transmitting a signal to the device 312 subsequent to the apparatus 302 receiving the common TA value. The unicast transmission may be received by the apparatus subsequent to transmitting the signal. In some embodiments, the updated TA-related information is based on the signal. The signal may be a UTS.

In some embodiments, the at least one TA value comprises a respective TA value for each of at least some of the apparatuses, including for the apparatus 302. In some embodiments, the TA value for the apparatus 302 may be identified in the group message using an identification (ID) associated with the apparatus 302, e.g. a group ID. In some embodiments, the TA value for the apparatus 302 is based on a position of the apparatus 302.

In some embodiments, the method may include the apparatus 302 transmitting information with a time offset that is based on the at least one TA value.

In some embodiments, the group message may be received during a wake-up duration of the apparatus 302 when the apparatus is in a power saving state. In some embodiments, the power saving state is a state in which the apparatus 302 does not monitor DCI until it enters a wake-up duration. An example of a wake-up duration is a DRX_on duration. In some embodiments, the power saving state is a state in which the apparatus 302 occupies fewer resources available for downlink and/or uplink transmission compared to a non-power saving state, and/or the apparatus 302 utilizes fewer transmission parameters compared to a non-power saving state. As a result, the apparatus 302 consumes less power than when in a non-power saving state. The power saving state may include more than one power mode to operate at different levels of functionality within the power saving state.

In some embodiments, the TA-related information is not received by the apparatus 302 in response to transmission of a preamble by the apparatus. For example, the TA-related information is not received during a RACH process.

From the perspective of the device 312, the following may be possible in the method of FIG. 16.

In some embodiments, the at least one TA value is a common TA value for at least some of the apparatuses in the group, and subsequent to transmitting the common TA value, the method may include: the device 312 transmitting, to a particular apparatus that received the common TA value, a unicast transmission that includes updated TA-related information for the particular apparatus. In some embodiments, the method may include the device 312 receiving a signal from the particular apparatus and determining the updated TA-related information based on the signal. The signal may be a UTS.

In some embodiments, the least one TA value may be or include a respective TA value for each apparatus of at least one apparatus in the group, and the TA value for a particular apparatus may be identified in the group message using an identification (ID) (e.g. UE ID) associated with the particular apparatus. In some embodiments, the TA value for the particular apparatus is based on a position of the particular apparatus.

In some embodiments, the group message is transmitted during a wake-up duration of at least the apparatus 302 when the apparatus 302 is in a power saving state. In some embodiments, the power saving state is a state in which the apparatus 302 does not monitor DCI until it enters a wake-up duration. An example of a wake-up duration is a DRX_on duration. In some embodiments, the power saving state is a state in which the apparatus 302 occupies fewer resources available for downlink and/or uplink transmission compared to a non-power saving state, and/or the apparatus 302 utilizes fewer transmission parameters compared to a non-power saving state. As a result, the apparatus 302 consumes less power than when in a non-power saving state. The power saving state may include more than one power mode to operate at different levels of functionality within the power saving state.

In some embodiments, the TA-related information is not transmitted in response to receiving a preamble from the apparatus 302.

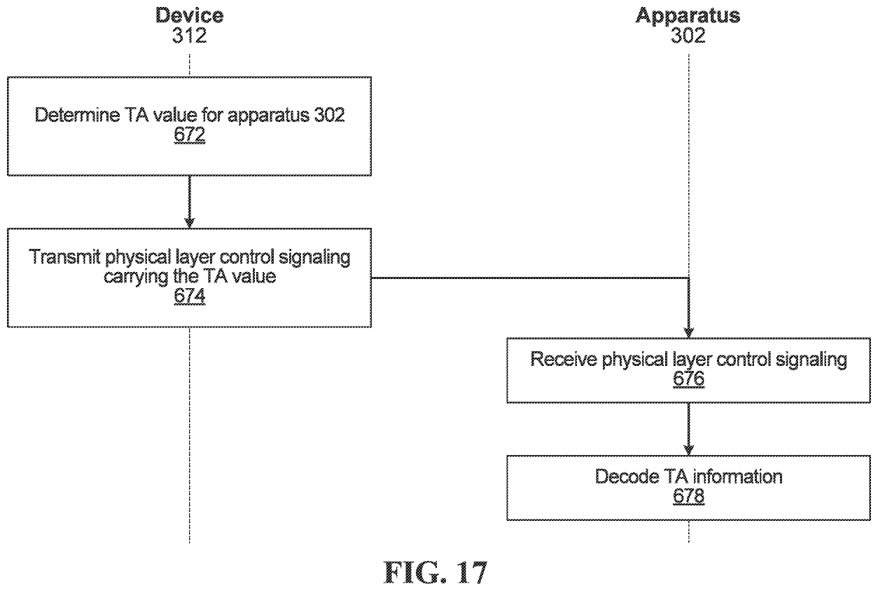

FIG. 17 illustrates a method performed by apparatus 302 and device 312, according to another embodiment. The apparatus 302 may be a UE, e.g. UE 110, although not necessarily. The device 312 may be a network device, e.g. base station 170, although not necessarily.

At step 672, the device 312 determines a TA value for the apparatus 302. At step 674, the device 312 transmits physical layer control signaling to the apparatus 302. The physical layer control signaling carries the TA value for the apparatus 302. At step 676, the apparatus 302 receives the physical layer control signaling. At step 678, the apparatus 302 decodes the TA value.

In some embodiments, the TA value is transmitted/received in a unicast message. In some embodiments, the physical layer control signaling has its CRC scrambled by an identification (ID) of the apparatus 302 (e.g. scrambled by the UE ID for the apparatus 302). In some embodiments, the physical layer control signaling comprises DCI. In some embodiments, the TA value is based on a position of the apparatus 302.

In some embodiments, the TA value is transmitted/received during a wake-up duration of the apparatus 302 when the apparatus is in a power saving state. In some embodiments, the power saving state is a state in which the apparatus 302 does not monitor DCI until it enters a wake-up duration. An example of a wake-up duration is a DRX_on duration. In some embodiments, the power saving state is a state in which the apparatus 302 occupies fewer resources available for downlink and/or uplink transmission compared to a non-power saving state, and/or the apparatus 302 utilizes fewer transmission parameters compared to a non-power saving state. As a result, the apparatus 302 consumes less power than when in a non-power saving state. The power saving state may include more than one power mode to operate at different levels of functionality within the power saving state.

In some embodiments, the TA value is not transmitted/received in response to transmission of a preamble by the apparatus 302. In some embodiments, the TA value is not in a RAR message.

In some embodiments, the method may include the device 312 transmitting and the apparatus 302 receiving an indication of a time-frequency resource at which the physical layer control information is to be received. In some embodiments, the TA value is an absolute value or a relative value. In some embodiments, the method may include the apparatus 302 transmitting information with a time offset that is based on the TA value.

In some embodiments, the method may include the device 312 obtaining an updated position of the apparatus 302 relative to the device 312. The method may further include the device 312 determining an updated TA value based on the updated position. The method may further include the device 312 transmitting the updated TA value to the apparatus 302.

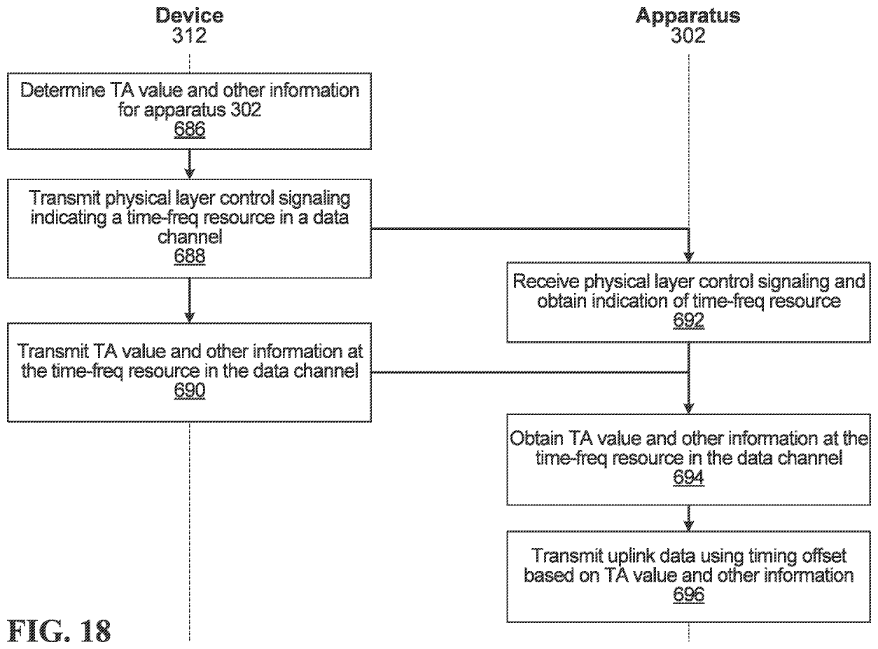

FIG. 18 illustrates a method performed by apparatus 302 and device 312, according to another embodiment. The apparatus 302 may be a UE, e.g. UE 110, although not necessarily. The device 312 may be a network device, e.g. base station 170, although not necessarily.

At step 686, the device 312 determines, for the apparatus 302, a TA value and other information. The other information may be associated with timing advance or synchronization for the apparatus 302. Examples of such information are described earlier. At step 688, the device 312 transmits physical layer control signaling to the apparatus 302. The physical layer control signaling indicates a time-frequency resource in a data channel. At step 690, the device 312 transmits, at the time-frequency resource in the data channel, the TA value and the other information for the apparatus 302. At step 692, the apparatus 302 receives the physical layer control signaling and obtains the indication of the time-frequency resource. Steps 690 and 692 may happen in parallel or in reverse order. At step 694, the apparatus 302 obtains, at the time-frequency resource in the data channel, the TA value for the apparatus 302 and the other information for the apparatus 302. At step 696, the apparatus 302 transmits uplink data using a timing offset that is based on the TA value and the other information. Examples of other information are described earlier. As a simple example, the other information may be a timing reference point or an indication of a beam direction. The apparatus 302 may apply a timing offset based on the TA value and the other information (e.g. the timing reference point or the indicated beam direction).

Examples of a device 312 and an apparatus 302 to perform the methods are also disclosed.

The device 312 may include a memory to store processor-executable instructions, and a processor to execute the processor-executable instructions. When the processor executes the processor-executable instructions, the processor may be caused perform the method steps of the device 312 as described above, e.g. in relation to FIGS. 16 to 18. As an example, the processor may determine a TA value and generate the physical layer control signaling for transmission. In some embodiments, the device 312 may be a circuit chip.

The apparatus 302 may include a memory to store processor-executable instructions, and a processor to execute the processor-executable instructions. When the processor executes the processor-executable instructions, the processor may be caused to perform the method steps of the apparatus 302 as described above, e.g. in relation to FIGS. 16 to 18. As an example, the processor may receive physical layer control signaling and perform decoding. In some embodiments, the apparatus 302 may be a circuit chip.

Methods for providing TA values are disclosed herein. In some embodiments, the methods may support fast access to the network for both uplink and downlink transmissions, e.g. by allowing for a UE to maintain uplink synchronization even when in a power-saving state. For example, a UE may be able to perform quick data transmission or reception upon traffic arrival, regardless of the UE's operating state or mode. Some embodiments may allow for effective TA adjustment while minimizing power saving, e.g. by providing TA adjustments when in a power-saving state. In some embodiments, signaling may be saved (e.g. in group-cast embodiments) and/or power usage in the network or the UE may be reduced (e.g. by allowing for default operation in a power-saving state). The variety of embodiments and possible implementations described herein provide many options for TA schemes for future networks. Unicast and/or group-cast based TA schemes may be provided to accommodate different TA adjustment scenarios including different TAGs, which may be applied for different carrier frequency bands, different numerologies, etc. Note that for low frequency bands, the cyclic prefix (CP) might offer some protection on timing error such that the TA value might not need to be updated as often. The same may be the case for different SCSs.

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

1. A method performed by an apparatus, the method comprising:
receiving physical layer control signaling, the physical layer control signaling carrying a group message including timing advance (TA) related information, the group message for a group of apparatuses including the apparatus; and
decoding the group message to obtain the TA related information.

2. The method of claim 1, wherein the TA related information indicates at least one TA value or indicates a time-frequency resource in a data channel at which at least one TA value is located.

3. The method of claim 1, wherein the group message is associated with a group ID, and the physical layer control signaling includes a cyclic redundancy check (CRC) scrambled using the group ID.

4. The method of claim 2, wherein the at least one TA value is a common TA value for at least some of the group of apparatuses, including the apparatus.

5. The method of claim 4, wherein subsequent to receiving the common TA value, the method comprises: receiving a unicast transmission that includes updated TA-related information for the apparatus.

6. The method of claim 2, wherein the at least one TA value comprises a respective TA value for each of at least some of the group of apparatuses, including for the apparatus, and wherein the TA value for the apparatus is identified in the group message using an identification (ID) associated with the apparatus.

7. The method of claim 2, further comprising transmitting information with a time offset that is based on the at least one TA value.

8. An apparatus comprising:
a memory to store processor-executable instructions;
a processor to execute the processor-executable instructions to cause the processor to:
receive physical layer control signaling, the physical layer control signaling carrying a group message including timing advance (TA) related information, the group message for a group of apparatuses including the apparatus;
decode the group message to obtain the TA related information.

9. The apparatus of claim 8, wherein the TA-related information indicates at least one TA value or indicates a time-frequency resource in a data channel at which at least one TA value is located.

10. The apparatus of claim 8, wherein the group message is associated with a group ID, and the physical layer control signaling includes a cyclic redundancy check (CRC) scrambled using the group ID.

11. The apparatus of claim 10, wherein the at least one TA value is a common TA value for at least some of the group of apparatuses, including the apparatus.

12. The apparatus of claim 11, wherein subsequent to obtaining the common TA value, the processor is to receive a unicast transmission that includes updated TA-related information for the apparatus.

13. The apparatus of claim 10, wherein the at least one TA value comprises a respective TA value for each of at least some of the group of apparatuses, including for the apparatus, and wherein the TA value for the apparatus is identified in the group message using an identification (ID) associated with the apparatus.

14. The apparatus of claim 9, wherein the processor is to cause transmission of information with a time offset that is based on the at least one TA value.

15. A method performed by a device, the method comprising:
determining at least one timing advance (TA) value for at least one apparatus in a group of apparatuses; and
transmitting physical layer control signaling, the physical layer control signaling carrying a group message for the group of apparatuses, the group message including TA-related information, wherein the TA-related information is associated with the at least one TA value.

16. The method of claim 15, wherein the group message is associated with a group ID, and the physical layer control signaling includes a cyclic redundancy check (CRC) scrambled using the group ID.

17. The method of claim 15, wherein the at least one TA value is a common TA value for at least some of the group of apparatuses.

18. The method of claim 17, wherein subsequent to transmitting the common TA value, the method comprises: transmitting, to a particular apparatus that received the common TA value, a unicast transmission that includes updated TA-related information for the particular apparatus.

19. The method of claim 15, wherein the at least one TA value comprises a respective TA value for each apparatus of the at least one apparatus, and wherein the TA value for a particular apparatus is identified in the group message using an identification (ID) associated with the particular apparatus.

20. The method of claim 15, wherein the group message is transmitted during a wake-up duration of the at least one apparatus when the at least one apparatus is in a power saving state.
